(19) United States
(12) Patent Application Publication
(10) Pub. No.: US 2009/0221435 A1
(43) Pub. Date: Sep. 3, 2009

(54) MICROARRAY FOR DETECTING AND QUANTIFYING MICRORNA

(75) Inventors: Scott Baskerville, Louisville, CO (US); Fiona M. Jucker, Boulder, CO (US); Anastasia Khvorova, Boulder, CO (US)

Correspondence Address: MERCHANT & GOULD PC, P.O. BOX 2903, MINNEAPOLIS, MN, 55402-0903, US

(73) Assignee: DHARMACON, INC., Lafayette, CO (US)

(21) Appl. No.: 12/278,395

(22) PCT Filed: Feb. 7, 2007
(86) PCT No.: PCT/US2007/003116

§ 371 Date: May 11, 2009

Related U.S. Application Data
(60) Provisional application No. 60/771,312, filed on Feb. 8, 2006.
(60) Provisional application No. 60/790,975, filed on Apr. 11, 2006.

(51) Int. Cl. C40B 30/04; C40B 40/06

(52) U.S. Cl. 506/9; 506/16

(57) ABSTRACT

A microarray can be configured for hybridizing with short nucleic acids, such as miRNA or siRNA, contained within a sample. Such a microarray includes a polynucleotide trap coupled to a substrate of a microarray site. The polynucleotide trap includes a probe that selectively hybridizes with short nucleic acid sequences, and a linker that is coupled to the substrate and configured to extend the probe from the substrate. Additionally, the polynucleotide trap can include an enhancer that hybridizes with the linker in order to enhance functionality of the probe. The linker and/or enhancer are configured to inhibit the probe from interacting with the linker or substrate. This can include the linker and/or enhancer being configured to have a minimal secondary structure so as to present the probe region for hybridizing with the target polynucleotide and inhibit the linker region or probe region from interacting with the substrate.

### CROSS-REFERENCE TO RELATED APPLICATIONS

This PCT Application claims the benefit of U.S. Provisional Application Ser. No. 60/771,312, which was filed on Feb. 8, 2006, and U.S. Provisional Application Ser. No. 60/790,975, filed Apr. 11, 2006, which provisional applications are both incorporated herein in their entirety by specific reference.

### BACKGROUND OF THE INVENTION

1. The Field of the Invention

The present invention is related to microarray technology for detecting and quantifying RNA, such as miRNA, in a sample. More particularly, the present invention is related to probe oligonucleotides, linker oligonucleotides, enhancer oligonucleotides, microarrays, microRNA, labeled microRNA, and methods of making and using the same in order to detect and/or quantify miRNA in a sample.

2. Background

RNA interference (RNAi) is a natural cellular pathway that modulates gene expression by post-transcription mechanisms. The key effector molecule of RNAi is the micro RNA (miRNA or miR). As shown in FIG. 1, these small, non-coding RNAs are first transcribed as primary miRNAs (pri-miRNA) and subsequently processed in the nucleus by Drosha (a Type III ribonuclease) to generate pre-miRNAs. These smaller hairpin molecules are then transported to the cytoplasm where they are processed by a second nuclease, Dicer, before being incorporated into the RNA Induced Silencing Complex (RISC). Subsequent interactions between the mature miRNA-RISC complex and messenger RNA (mRNA) leads to gene knockdown by transcript cleavage and/or translation attenuation (Pillai, R. S. (2005) “MicroRNA function: multiple mechanisms for a tiny RNA?” RNA, 11(12):1753-61).

While study of miRNA has garnered considerable interest in recent years, the RNAi pathway has also been recognized as a powerful research tool. Small double stranded RNAs, which are referred to as small interfering RNAs (siRNA), derived from synthetic chemistries or enzymatic methods can enter the pathway and target specific gene transcripts for degradation. As such, the RNAi pathway serves as a potent tool in the investigation of gene function, pathway analysis, and drug discovery.

In some instances, it may be desirable to detect the presence or quantity of miRNA or siRNA, or any other nucleic acid, in a cell, tissue, biological fluid, or other sample. Unfortunately, the sheer number of miRNA and the small size of these molecules, make traditional techniques such as Northern Blot analysis and PCR challenging. Alternative methods to detect RNAs include microarrays (see, Goldsmith, Z. G. et al. (2004) “The microrevolution: applications and impacts of microarray technology on molecular biology and medicine,” Int J Mol Med 13(4):483-95; Cheung V. G. et al. (1999) “Making and reading microarrays,” Nature Genetics Supplement, vol. 21). Microarrays, also known as biochips, have been developed to simultaneously quantify various biopolymer species, such as DNA and RNA sequences that are present in a sample in different amounts. In a typical biochip analysis, different probe biopolymers (e.g., DNA, RNA, or DNA/RNA molecules) are immobilized on a surface of a support (e.g., glass slide) to selectively bind to different labeled biopolymers (e.g., RNA sequence) in a sample through hybridization. Specific sample biopolymers can then be quantified by measuring the amount of the label that has been selectively coupled to the probe biopolymers during the hybridization. This principle makes it possible to quantify many different sample biopolymers in a single sample by immobilizing many different probe biopolymers on the same support.

While biochips are regularly used to assess the presence of mRNA in various cell and tissue types, a variety of technical hurdles associated with sensitivity make the application of this technique to smaller RNA (e.g., miRNA or siRNA) problematic. Krichevsky and co-workers (Krichevsky, A. M. (2003) “A microRNA array reveals extensive regulation of microRNAs during brain development,” RNA, 9:1274-1281) have developed arrays on nylon membranes and detected miRNA by labeling low molecular weight RNA with radioactive isotopes. Others have avoided the problems associated with radioactivity by employing 5′ biotinylated cDNAs of miRNAs (Liu, C. G. et al. (2004) “An oligonucleotide microchip for genome-wide microRNA profiling in human and mouse tissues,” PNAS 101:9740-9744). While all of these techniques have provided glimpses of the miRNA expression profile in cells, they are hindered by lack of sensitivity.

Accordingly, it would be advantageous to have a microarray that is configured for hybridizing with any RNA and/or DNA sequence. Additionally, it would be advantageous to have a microarray having a probe that selectively hybridizes with a RNA and/or DNA sequence.

### SUMMARY OF THE INVENTION

Generally, embodiments of the present invention include compositions, systems, and microarrays for use in methods for capturing a target polynucleotide. Usually, the polynucleotide is in a biological sample or a sample derived therefrom. By capturing the target polynucleotide, the presence of the target polynucleotide in the sample can be determined. Also, the amount of the target polynucleotide can be quantified when the target polynucleotide includes a measurable label. As such, the compositions and microarrays of the present invention can be used in methods for determining the presence of a target polynucleotide and/or quantifying the amount of the target polynucleotide in a sample.

In one embodiment, the present invention includes a microarray for capturing a target polynucleotide. The microarray includes a first oligonucleotide coupled to a substrate, such as glass, plastic, or silicon, of a microarray location. The first oligonucleotide is configured for capturing the target polynucleotide from a sample by having a probe region with a probe sequence configured for hybridizing with the target polynucleotide. Additionally, the first oligonucleotide includes a linker region having a first end or first region coupled to the probe region and a second end or second region coupled to the substrate. Usually, the substrate is a support, base, floor, or other feature of a microarray.

In one embodiment, the microarray includes a second oligonucleotide that can enhance the functionality of the first oligonucleotide. More particularly, the second oligonucleotide (i.e. enhancer nucleotide) includes an enhancer region configured for hybridizing with the linker region of the first oligonucleotide. Also, the second oligonucleotide is configured for extending the probe region from the substrate when the enhancer region is annealed to the linker region to form a duplex region. Moreover, the components of the microarray can be combined into a composition or formed into a system as described herein.

Optionally, the linker region is comprised of at least one pyrimidine nucleotide and/or the enhancer region is comprised of at least one purine nucleotide. Alternatively, the enhancer region is comprised of pyrimidine nucleotides and the linker region is comprised of purine nucleotides. Any of the nucleotides can be modified.

In one embodiment, the linker region and/or enhancer region can be configured to inhibit the probe region from interacting with the linker region or substrate. This can include the linker region being separately configured to inhibit such interactions, or being configured in conjunction with the enhancer region so that the linker region and enhancer region can hybridize to form a duplex region to inhibit such interactions.

In one embodiment, the linker region and/or enhancer region can be configured to have a minimal secondary structure so as to present the probe region for hybridizing with the target polynucleotide and inhibit the linker region or probe region from interacting with the substrate. Similarly, this includes the linker region being separately configured to inhibit such secondary structures, or being configured in conjunction with the enhancer region so that the linker region and enhancer region can hybridize to inhibit the formation of such secondary structures. Also, the linker region and enhancer region can hybridize so as to be substantially devoid of a secondary structure. The minimal secondary structure is obtained when one of the linker region or enhancer region consists of pyrimidine or purine nucleotides (e.g., modified or unmodified pyrimidine or purine nucleotides). When consisting of pyrimidine nucleotides, the linker region or enhancer region is any of the following: ctcttctctctcttctct (SEQ ID NO: 1); ctcttctctc (SEQ ID NO: 2; ctcttctctctcttctctctcttctctctcttctct (SEQ ID NO: 3); ctcttctctctcttctctctcttctctctcttctctct (SEQ ID NO: 4); combinations thereof; reverse complements thereof, or derivatives thereof. Correspondingly, the linker region or enhancer region can consist of purine nucleotides as follows: gagaagagagagaagaga (SEQ ID NO: 5); gagaagagag (SEQ ID NO: 6); gagaagagagagaagagagagaagagagagaagaga (SEQ ID NO: 7) gagaagagagagaagagagagaagagagagaagagaga (SEQ ID NO: 8) combinations thereof; reverse complements thereof, or derivatives thereof.

In one embodiment, the probe region has 100% complementarity with the target polynucleotide. Alternatively, the probe region has greater than 70% complementarity with the target polynucleotide. Also, the probe region has a length from about 12 to about 27 nucleotides. In one embodiment, the probe region is linked to the 5′ end of the linker region. Also, the linker region has a length from about 13 to about 100 nucleotides.

In one embodiment, the probe polynucleotide sequence is capable of being annealed to a full-length mature miRNA. In one embodiment, the probe polynucleotide sequence is capable of being annealed to a mature miRNA strand sans a seed region. In one embodiment, the probe polynucleotide sequence and the target polynucleotide is capable of hybridizing with a maximum melting temperature from about 45° C. to about 60° C.

In one embodiment, the first and/or second oligonucleotides have a nucleotide that includes a 2′ modification. For example, the probe region and/or linker region of the first oligonucleotide and/or the enhancer region of the second oligonucleotide can include 2′ modifications. Such 2′ modifications can be ACE modifications. Alternatively, the 2′ modifications can be 2′-O-alkyl modifications, such as 2′-O-methyl or 2′-O-ethyl modifications.

In one embodiment, the present invention includes methods for detecting nucleic acids using the microarray. Such methods include providing a microarray having a plurality of array locations, wherein each array location includes a plurality of polynucleotide traps. Each polynucleotide trap is comprised of the first and second oligonucleotides described above or elsewhere herein. Usually, the first oligonucleotide has a probe region configured for capturing a target polynucleotide, and a linker region that has a first end coupled to the probe region and a second region coupled to a substrate. The second oligonucleotide includes an enhancer region annealed to the linker region. A sample possibly having the target polynucleotide is then contacted to the microarray, and more particularly to each of the plurality of array locations having the polynucleotide traps. The sample is then analyzed to determine whether the sample includes the target polynucleotide. The amount of target polynucleotide annealed to the probe regions of the plurality of polynucleotide traps is then determined.

In one embodiment, the target polynucleotide is labeled so that the presence of the target polynucleotide can be identified and/or quantified. In one embodiment, the label is a fluorescent label. Also, the amount of target polynucleotide can be determined by quantifying the amount of label.

In one embodiment, the present invention includes another method for detecting nucleic acids using a microarray. This method includes providing a microarray having a plurality of array locations, wherein each array location includes a plurality of polynucleotide traps. Each of the polynucleotide traps includes a first oligonucleotide having a probe region and a linker region. The probe region is configured for capturing a target polynucleotide, and the linker region has a first end coupled to the probe region and a second region coupled to a substrate. A second oligonucleotide is then contacted to the microarray so as to come into contact with the polynucleotide trap. The second oligonucleotide includes an enhancer region that is capable of annealing to the linker region so as to form a duplex region. Additionally, a sample having the target polynucleotide is then contacted to the microarray, and more particularly to each of the plurality of array locations having the polynucleotide traps. The amount of target polynucleotide annealed to the probe regions of the plurality of enhanced polynucleotide traps is then determined.

In one option, the second oligonucleotide including the enhancer region is contacted to the microarray before the sample is contacted to the microarray. In another option, the second oligonucleotide including the enhancer region is contacted to the microarray at the same time the sample is contacted to the microarray.

These embodiments and other embodiments of the present invention are described in more detail below and in the figures, which are described herein.

### BRIEF DESCRIPTION OF THE FIGURES

The preferred embodiments of the present invention have been chosen for purposes of illustration and description but are not intended to restrict the scope of the invention in any way. The benefits of the preferred embodiments of certain aspects of the invention are shown in the accompanying figures.

FIG. 1 shows a depiction of the RNAi pathway.

FIG. 2A shows a depiction of the equilibrium between unimolecular and bimolecular reactions for a target nucleic acid.

FIG. 2B shows a depiction of the deleterious interactions that can occur between the linker and the probe, the substrate and the probe, and the linker and the substrate.

FIG. 3 depicts an embodiment of a polynucleotide trap that includes a first oligonucleotide comprising probe and linker sequences, and a second oligonucleotide comprising the enhancer sequence.

FIG. 4 depicts embodiments of different probe design strategies.

FIG. 5 depicts embodiments of different linker-probe design strategies and the position of the enhancer sequence in each design.

FIG. 6A is a graph that depicts the distribution of signal for ˜500 Cy3 labeled probes having either the ND5 design (open circles, line) or the ND1 design (closed circles) in the absence of an ND1 enhancer sequence.

FIG. 6B is a graph that depicts the distribution of signal for ˜500 Cy3 labeled probes having either the ND5 design (open circles, line) or the ND1 design (closed circles) in the presence of an ND1 enhancer sequence.

FIG. 7A is a graph that depicts the distribution of signal for ˜500 Cy3 labeled probes having either the ND5 design (open circles, line) or the ND2 design (closed circles) in the absence of an ND2 enhancer sequence.

FIG. 7B is a graph that depicts the distribution of signal for ˜500 Cy3 labeled probes having either the ND5 design (open circles, line) or the ND2 design (closed circles) in the presence of an ND2 enhancer sequence.

FIG. 8A is a graph that depicts the distribution of signal for ˜500 Cy3 labeled probes having either the ND5 design (open circles, line) or the ND3 design (closed circles) in the absence of an ND3 enhancer sequence.

FIG. 8B is a graph that depicts the distribution of signal for ˜500 Cy3 labeled probes having either the ND5 design (open circles, line) or the ND3 design (closed circles) in the presence of an ND3 enhancer sequence.

FIG. 9A is a graph that depicts the distribution of signal for ˜500 Cy3 labeled probes having either the ND5 design (open circles, line) or the ND4 design (closed circles) in the absence of an ND4 enhancer sequence.

FIG. 9B is a graph that depicts the distribution of signal for ˜500 Cy3 labeled probes having either the ND5 design (open circles, line) or the ND4 design (closed circles) in the presence of an ND4 enhancer sequence.

FIG. 10 is a series of graphs that depict the results when enhancer concentrations are varied.

FIG. 11 is a graph that depicts the linearity of the fluorescent signal at different target concentrations for three different human miRs (Y-axis=fluorescent intensity; X-axis represents the concentration of the labeled miR).

FIG. 12 is a graph that depicts the number of miRs that provide a given level of fluorescent intensity at 3×10-16 mol/feature (Y axis=numbers of different miRs; X-axis represents the fluorescent intensity). All miRs that generate signals above background (to the right of the dotted line) can be distinguished from background at this concentration.

FIG. 13 is a graph that depicts the relative ratio of all human miRNAs in liver versus brain tissues.

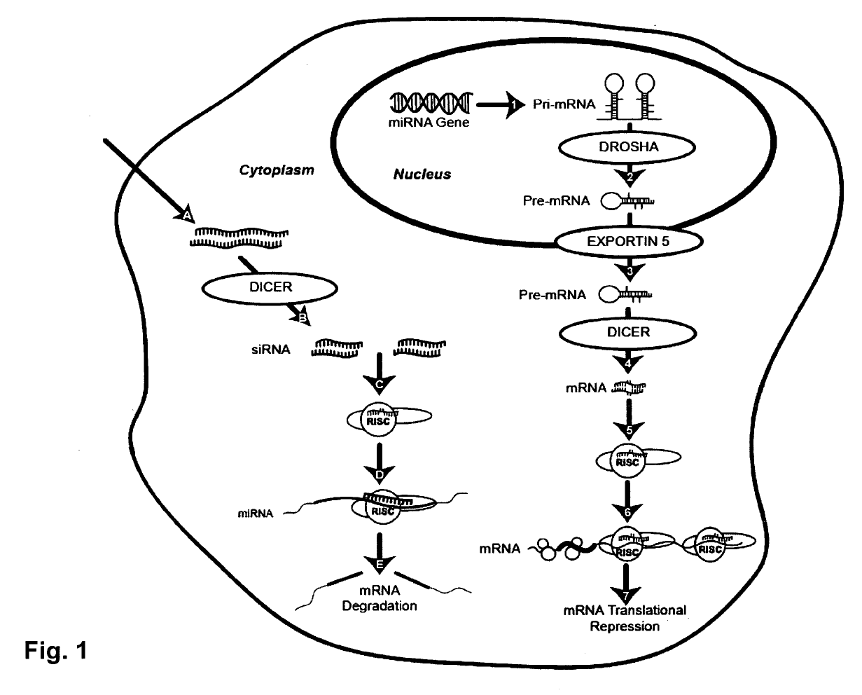

### DETAILED DESCRIPTION OF PREFERRED EMBODIMENTS

The present invention will now be described in connection with preferred embodiments. These embodiments are presented to aid in an understanding of the present invention and are not intended, and should not be construed, to limit the invention in any way. All alternatives, modifications, and equivalents that may become apparent to those of ordinary skill upon reading this disclosure are included within the spirit and scope of the present invention. As such, this disclosure is not a primer on compositions and methods for performing microarray-based gene profiling. Basic concepts known to those skilled in the art have been set forth in detail.

### I. Introduction

Generally, embodiments of the present invention include a polynucleotide trap that is configured for hybridizing with short nucleic acid sequences, such as miRNA or siRNA. Additionally, embodiments of the present invention include a polynucleotide trap having a probe that selectively hybridizes with short nucleic acid sequences, and having a linker that is configured so as to avoid hybridizing with the probe, target nucleotide sequence, or substrate attached to the polynucleotide trap. Further, embodiments of the invention include a polynucleotide trap that has an enhancer oligonucleotide that hybridizes with the linker in order to enhance functionality of the probe. Furthermore, embodiments of the invention include a composition, system, or microarray having polynucleotide traps that are configured for hybridizing with short nucleic acid sequences.

Accordingly, embodiments of the present invention include compositions and methods for using the nucleotide traps and microarray for performing microarray-nucleic acid profiling. Such nucleic acid profiling can include detecting the presence and/or quantifying the amount of target nucleic acids. Through the use of the present invention, modified polynucleotides, and derivatives thereof, methods of using microarrays are improved for the detection and/or quantification of target nucleic acids. While the present invention is described in connection with miRNA, reference to miRNA is intended to generally cover other target nucleic acids, such as DNA, RNA, DNA/RNA hybrids, mRNA, siRNA, short RNA, and the like.

Previously, microarray technologies have been developed to detect and quantitate RNA (see Thompson, K. L. et al (2005), “Use of a mixed tissue RNA design for performance assessments on multiple microarray formats,” Nucleic Acids Res 33(22):e187; Schlomm, T. et al. (2005), “Extraction and processing of high quality RNA from impalpable and macroscopically invisible prostate cancer for microarray gene expression analysis,” Int J Oncol; 27(3):713-20). Such microarray technologies can be modified or configured as described herein in accordance with the present invention. In cases where the RNA to be detected represents a population of miRNA, probes that are complementary and specific to a particular region of each target miRNA can be developed. These probes are often distributed across a solid support in an arrayed format and employ a linker sequence to position the probe sequence away from the support surface so that the probe can interact with the target miRNA. Subsequently, the attached probes are exposed to samples containing labeled miRNA (e.g., fluorescently labeled) under conditions where the probe and target miRNA are capable of annealing. The methods of using the microarrays in accordance with the present invention can detect whether the labeled miRNA are present in the sample, and/or quantitate the amount of signal associated with each position in the array, and determine the relative expression levels or amounts of each miRNA.

The present invention includes parameters that can be modulated in order to optimize the function of a polynucleotide trap and/or microarray including the same. While the basic concepts of microarray-based detection are easily comprehended, a number of hurdles may be associated with developing polynucleotide traps to capture a target nucleic acid in a heterogeneous population of molecules (e.g., all the miRNA in a cell). In a microarray where multiple polynucleotide traps are localized to different positions on an array, all of the probes on a particular array can be configured to have similar annealing characteristics with their respective target molecules. In part, this can be achieved by ensuring that all of the probe-target duplexes have similar melting temperatures (Tm). Also, the following parameters can be modulated to optimize function of the microarray and/or polynucleotide trap: optimizing probe length; optimizing GC content; optimize or reduce secondary structure; temperature; salt concentration; and optimize other parameters that play a role in duplex thermodynamic stability. For example, an optimal microarray can include one or more polynucleotide traps that are configured such that a single hybridization condition (e.g., temperature, ionic concentration, etc.) can be used to capture the heterogeneous population of labeled miRNAs in solution with equal efficiency. This can allow all of the probes to hybridize with their respective target miRNAs at one hybridization condition.

In one embodiment, the length of the probe can be modulated in accordance with the length of the target miRNA or a length of sequence in the target miRNA. In part, the ability to optimize probes can be correlated to the length of the target miRNA. In instances where the target miRNAs are long (e.g., a population of miRNAs), a library of potential probe sequences can be designed (e.g., in silico) for each target sequence or portion of the sequence, and the potential probe sequences can be subsequently screened for desired annealing properties (e.g., Tm).

In some instances, the target is a small miRNA such that the short length of the mature miRNA sequence (e.g., 17-28 nucleotides) may limit the number of probe sequences available. Under these conditions, identifying sequences that have near identical annealing properties can be challenging. As such, optimization of microarray parameters, other than sequence, can be beneficial to promote hybridization between the probe and the miRNA.

In one embodiment, a polynucleotide trap can be configured such that the probe preferably hybridizes with the target nucleic acid. As such, this can include increasing the opportunity for the target nucleic acid to hybridize with the probe rather than having an unfavorable hybridization. Also, this can include preventing the probe from having unfavorable interactions.

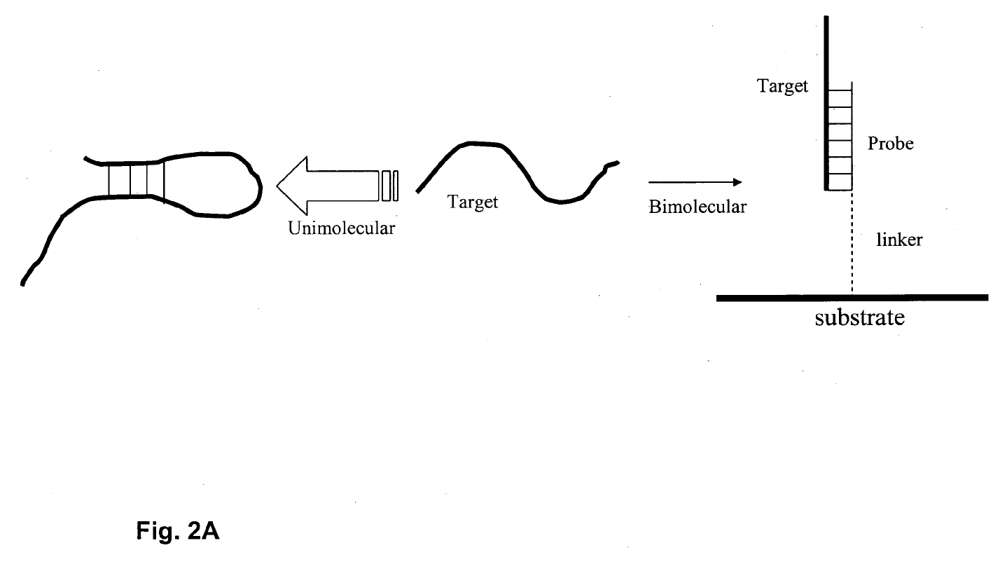

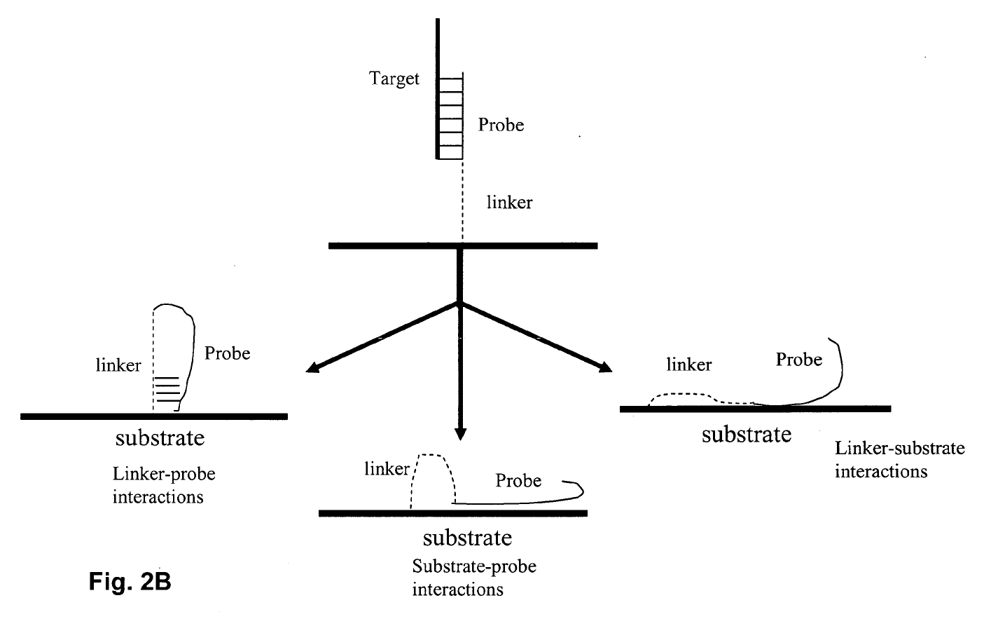

FIG. 2A depicts a possible equilibrium between unimolecular and bimolecular reactions for a target nucleic acid, wherein probe-target nucleic acid interactions can be viewed as a complex equilibrium between the unimolecular and bimolecular states. The unimolecular state shows that the target nucleic acid may hybridize with itself because some fraction of the target nucleic acids may be capable of folding back upon themselves (e.g. a unimolecular reaction), thus limiting the ability to anneal with the probe. Also, the target nucleic acid may hybridize with other nucleic acids that have at least partial complementarity. Thus, the probe can be configured to preferentially hybridize with the target nucleic acid, as shown by the bimolecular reaction, to avoid interactions (e.g., unimolecular reaction) that may prevent the probe from hybridizing with the target nucleic acid.

FIG. 2B shows some interactions that can be unfavorable and inhibit the probe from hybridizing with the target nucleic acid. Such unfavorable interactions can include the following: the probe hybridizing with the linker portion of the polynucleotide trap; the probe hybridizing with the substrate coupled to the polynucleotide trap; and the linker hybridizing with the substrate coupled to the polynucleotide trap. Thus, the polynucleotide trap can be configured to preferentially inhibit such unfavorable interactions. This can increase the opportunity for the probe to hybridize with the target nucleic acid.

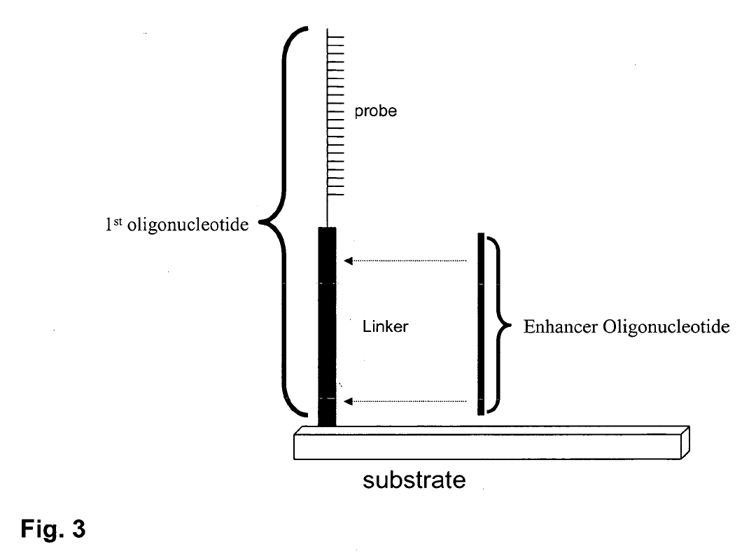

FIG. 3 is a schematic diagram depicting an embodiment of a polynucleotide trap attached at one end to a substrate. The polynucleotide trap includes a first oligonucleotide having a probe region and a linker region, and a second oligonucleotide including an enhancer region. As such, the second oligonucleotide can be considered an enhancer oligonucleotide. Specifically, the polynucleotide trap can include the following: a first oligonucleotide comprising two regions, a first region referred to as the linker region that connects the first oligonucleotide to the substrate or solid support, and a second region, referred to as the probe region, that is associated with the linker region and is complementary to a target oligonucleotide; and a second oligonucleotide, also referred to as an enhancer oligonucleotide, having an enhancer region that is capable of annealing to the linker region and simultaneously minimize the interactions of the linker and/or probe regions with the solid support. The polynucleotide trap having the first oligonucleotide hybridized with the enhancer oligonucleotide can enhance the rigidity of the linker region, and can maximize the ability of the probe region to anneal with target nucleic acids. Additionally, the first oligonucleotide having the linker region and the probe region can be considered to be a polynucleotide trap configured for trapping a target polynucleotide. Moreover, the combination of the first oligonucleotide and the second oligonucleotide, wherein the enhancer region is hybridized to the linker region can be considered to be an enhanced polynucleotide trap configured for trapping a target polynucleotide.

In one embodiment, a microarray includes the enhancer oligonucleotided directly coupled thereto. As such, the first ologonucleotide is indirectly coupled to the substrate through the enhancer oligonucleotide. This can be facilitated by the linker region of the first oligonucleotide being hybridized to the enhancer, which in turn is bound to the substrate of the microarray.

In one embodiment, the polynucleotide trap or enhance polynucleotide trap can be used in a method for detecting or quantifying target nucleic acids in a sample. Such a method can include one or more of the following: (a) one or more first oligonucleotides having a probe region that recognizes one or more target oligonucleotides are associated with a solid support via the linker region; (b) exposing the first oligonucleotide to an enhancer oligonucleotide having an enhancer region that is complementary to the linker region under conditions where the enhancer region and linker region anneal; (c) exposing the solid support containing the linker-probe/enhancer complex to a mixture containing labeled nucleic acid targets under conditions whereby the labeled nucleic acid targets can anneal to their respective probe regions; and (d) quantitating the amount of label associated with each probe or probe position on an array to determine the relative amount of nucleic acid target at each position. In the foregoing method, steps (b) and (c) can take place consecutively. Alternatively, the enhancer oligonucleotide can be mixed with the labeled nucleic acid targets and the annealing reactions between linker region and enhancer region, as well as probe region and labeled target nucleic acid, can take place simultaneously.

1. Definitions

Unless stated otherwise, the following terms and phrases have the meanings provided below.

As used herein, “2′ carbon modification” and “2′ modification” are interchangeable and refer to a nucleotide unit having a sugar moiety that is modified at the 2′ position of the sugar subunit. A “2′—O-alkyl modified nucleotide” is modified at this position such that an oxygen atom is attached both to the carbon atom located at the 2′ position of the sugar and to an alkyl group (e.g., 2′-O-methyl, 2′-O-ethyl, 2′-O-propyl, 2′-O-isopropyl, 2′-O-butyl, 2-O-isobutyl, 2′-O-ethyl-O-methyl (—OCH₂CH₂OCH₃), and 2′-O-ethyl-OH(—OCH₂CH₂OH)).

As used herein, “2′—O-alkyl modified nucleotide” refers to a nucleotide unit having a sugar moiety, for example a deoxyribosyl moiety that is modified at the 2′ position such that an oxygen atom is attached both to the carbon atom located at the 2′ position of the sugar and to an alkyl group. In various embodiments, the alkyl moiety consists essentially of carbons and hydrogens. A particularly preferred embodiment is one wherein the alkyl moiety is methyl moiety.

As used herein, “alkyl” refers to a hydrocarbyl moiety that can be saturated or unsaturated, and substituted or unsubstituted. It may comprise moieties that are linear, branched, cyclic and/or heterocyclic, and contain functional groups such as ethers, ketones, aldehydes, carboxylates, etc. Unless otherwise specified, alkyl groups are not cyclic, heterocyclic, or comprise functional groups. Exemplary alkyl groups include but are not limited to substituted and unsubstituted groups of methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, and alkyl groups of higher number of carbons, as well as 2-methylpropyl, 2-methyl-4-ethylbutyl, 2,4-diethylpropyl, 3-propylbutyl, 2,8-dibutyldecyl, 6,6-dimethyloctyl, 6-propyl-6-butyloctyl, 2-methylbutyl, 2-methylpentyl, 3-methylpentyl, and 2-ethylhexyl. The term alkyl also encompasses alkenyl groups, such as vinyl, allyl, aralkyl and alkynyl groups. Unless otherwise specified, alkyl groups are not substituted. The preferred alkyl group for a 2′ modification is a methyl group with an O-linkage to the 2′ carbon of a ribosyl moiety (i.e., a 2′-O-alkyl that comprises a 2′-O-methyl group).

Substitutions within an alkyl group, when specified as present, can include any atom or group that can be tolerated in the alkyl moiety, including but not limited to halogens, sulfurs, thiols, thioethers, thioesters, amines (primary, secondary, or tertiary), amides, ethers, esters, alcohols, and oxygen. The alkyl groups can by way of example also comprise modifications such as azo groups, keto groups, aldehyde groups, carboxyl groups, nitro, nitroso or nitrile groups, heterocycles such as imidazole, hydrazino or hydroxylamino groups, isocyanate or cyanate groups, and sulfur containing groups such as sulfoxide, sulfone, sulfide, and disulfide. Unless otherwise specified, alkyl groups do not comprise halogens, sulfurs, thiols, thioethers, thioesters, amines, amides, ethers, esters, alcohols, oxygen, or the modifications listed above.

Further, alkyl groups may also contain hetero substitutions, which are substitutions of carbon atoms for example, nitrogen, oxygen or sulfur. Heterocyclic substitutions refer to alkyl rings having one or more heteroatoms. Examples of heterocyclic moieties include but are not limited to morpholino, imidazole, and pyrrolidino. Unless otherwise specified, alkyl groups do not contain hetero substitutions or alkyl rings with one or more heteroatoms (i.e., heterocyclic substitutions).

As used herein, “antisense strand” refers to a polynucleotide or region of a polynucleotide that is substantially (i.e., 80% or more) or completely (100%) complementary to a target nucleic acid of interest. As such, the probe region of the present invention can considered to be an antisense strand when the target nucleic acid is considered to be a sense strand. An antisense strand may be comprised of a polynucleotide region that is RNA, DNA, or chimeric RNA/DNA. For example, an antisense strand may be complementary, in whole or in part, to a molecule of target mRNA, siRNA, miRNA, tRNA, rRNA, hnRNA, and other RNA molecules. Also, the target can be a sequence of DNA that is either coding or non-coding. The phrases “antisense strand” and “antisense region” are intended to be equivalent and are used interchangeably. The antisense strand can be modified with a diverse group of small molecules and/or conjugates.

As used herein, “complementary” and “complementarity” are interchangeable and refer to the ability of polynucleotides to form base pairs with one another. Base pairs are typically formed by hydrogen bonds between nucleotide units in antiparallel polynucleotide strands or regions. Complementary polynucleotide strands or regions can base pair in the Watson-Crick manner (e.g., A to T, A to U, C to G). Perfect complementarity or 100% complementarity refers to the situation in which each nucleotide unit of one polynucleotide strand or region can hydrogen bond with each nucleotide unit of a second polynucleotide strand or region. Less than perfect complementarity refers to the situation in which some, but not all, nucleotide units of two strands or two regions can hydrogen bond with each other. Substantial complementarity refers to polynucleotide strands or regions exhibiting 80% or greater complementarity.

As used herein, “enhanced polynucleotide trap” refers to a first oligonucleotide and a second oligonucleotide being hybridized so that a probe region of the first oligonucleotide is extended from a substrate. This includes a linker region of the first oligonucleotide being hybridized with an enhancer region of the second oligonucleotide so as to enhance the functionality of the first oligonucleotide.

As used herein, “enhancer,” “enhancer oligonucleotide,” and “second oligonucleotide” are interchangeable and refer to a nucleic acid or modified oligonucleotide that has at least substantial complementarity to the linker region of the first oligonucleotide and capable of hybridizing therewith. Accordingly, the enhancer oligonucleotide can enhance the functionality of the first oligonucleotide by extending the probe region away from a substrate so as to be available for capturing target nucleic acids.

As used herein, “first oligonucleotide” refers to a polynucleic acid or modified nucleic acid sequence comprising a linker region that tethers the first oligonucleotide to the solid support, and a probe region that is sufficiently complementary to a target nucleic acid such that it can anneal to said target.

As used herein, “linker,” “linker region,” and “linker strand” are interchangeable and refer to a polynucleotide sequence that links a probe region of the first oligonucleotide to a solid support or substrate. In the present invention, the linker is also comprises one or more regions that are the reverse complement of the enhancer region.

As used herein, “microRNA,” “miRNA,” and “MiR” are interchangeable and refer to endogenous or synthetic non-coding RNAs that are capable of entering the RNAi pathway and regulating gene expression. “Primary miRNAs” or “pri-miRNA” represent the non-coding transcript prior to Drosha processing and include the hairpin(s) structure as well as 5′ and 3′ sequences. “Pre-miRNA” represent the non-coding transcript after Drosha processing of the pri-miRNA. The term “mature miRNA” can refer to the double stranded product resulting from Dicer processing of pre-miRNA or the single stranded product that is introduced into RISC following Dicer processing. In some cases, only a single strand of an miRNA enters the RNAi pathway. In other cases, two strands of an miRNA are capable of entering the RNAi pathway.

As used herein, “nucleotide” refers to a ribonucleotide or a deoxyribonucleotide or modified form thereof, as well as an analog thereof. Nucleotides include species that comprise purines (e.g., adenine, hypoxanthine, guanine) and their derivatives and analogs, and comprise pyrimidines (e.g., cytosine, uracil, thymine) and their derivatives and analogs. Preferably, a “nucleotide” comprises a cytosine, uracil, thymine, adenine, or guanine moiety.

Nucleotide analogs include nucleotides having modifications in the chemical structure of the base, sugar and/or phosphate, including but not limited to, 5-position pyrimidine modifications, 8-position purine modifications, modifications at cytosine exocyclic amines, and substitution of 5-bromo-uracil; and 2′-position sugar modifications, including but not limited to, sugar-modified ribonucleotides in which the 2′-OH is replaced by a group such as an H, OR, R, halo, SH, SR, NH2, NHR, NR2, or CN, wherein R is an alkyl moiety as defined herein. Nucleotide analogs are also meant to include nucleotides with bases such as inosine, queuosine, xanthine, sugars such as 2′-methyl ribose, non-natural phosphodiester linkages such as methylphosphonates, phosphorothioates, and peptides.

Modified bases refer to nucleotide bases, such as adenine, guanine, cytosine, thymine, uracil, xanthine, inosine, and queuosine that have been modified by the replacement or addition of one or more atoms or groups. Some examples of types of modifications that can comprise nucleotides that are modified with respect to the base moieties, include but are not limited to, alkylated, halogenated, thiolated, aminated, amidated, or acetylated bases, in various combinations. More specific modified bases include, for example, 5-propynyluridine, 5-propynylcytidine, 6-methyladenine, 6-methylguanine, N,N,-dimethyladenine, 2-propyladenine, 2-propylguanine, 2-aminoadenine, 1-methylinosine, 3-methyluridine, 5-methylcytidine, 5-methyluridine and other nucleotides having a modification at the 5 position, 5-(2-amino)propyl uridine, 5-halocytidine, 5-halouridine, 4-acetylcytidine, 1-methyladenosine, 2-methyladenosine, 3-methylcytidine, 6-methyluridine, 2-methylguanosine, 7-methylguanosine, 2,2-dimethylguanosine, 5-methylaminoethyluridine, 5-methyloxyuridine, deazanucleotides such as 7-deaza-adenosine, 6-azouridine, 6-azocytidine, 6-azothymidine, 5-methyl-2-thiouridine, other thio bases such as 2-thiouridine and 4-thiouridine and 2-thiocytidine, dihydrouridine, pseudouridine, queuosine, archaeosine, naphthyl and substituted naphthyl groups, any O- and N-alkylated purines and pyrimidines such as N6-methyladenosine, 5-methylcarbonylmethyluridine, uridine 5-oxyacetic acid, pyridine-4-one, pyridine-2-one, phenyl and modified phenyl groups such as aminophenol or 2,4,6-trimethoxy benzene, modified cytosines that act as G-clamp nucleotides, 8-substituted adenines and guanines, 5-substituted uracils and thymines, azapyrimidines, carboxyhydroxyalkyl nucleotides, carboxyalkylaminoalkyl nucleotides, and alkylcarbonylalkylated nucleotides. Modified nucleotides also include those nucleotides that are modified with respect to the sugar moiety, as well as nucleotides having sugars or analogs thereof that are not ribosyl. For example, the sugar moieties may be, or be based on, mannoses, arabinoses, glucopyranoses, galactopyranoses, 4′-thioribose and other sugars, heterocycles, or carbocycles. The term nucleotide is also meant to include what are known in the art as universal bases. By way of example, universal bases include but are not limited to 3-nitropyrrole, 5-nitroindole, or nebularine. Further, the term nucleotide also includes those species that have a detectable label, such as a radioactive or fluorescent moiety, or mass label attached to the nucleotide.

As used herein, “polynucleotide” refers to polymers of nucleotides, and includes but is not limited to, DNA, RNA, DNA/RNA hybrids and modifications of these kinds of polynucleotides wherein the attachment of various entities or moieties to the nucleotide units at any position are included. Unless otherwise specified, or clear from context, the term “polynucleotide” includes both unimolecular siRNAs, miRNAs, siRNAs, and miRNAs comprised of two separate strands.

As used herein, “polynucleotide trap” is meant to refer to a first oligonucleotide having a probe region and a linker region being attached to a substrate. That is, the linker region includes a first end, such as a terminal nucleotide, or a first region that is coupled to the substrate. As such, the probe region is coupled to the linker region at the second end or second region that is opposite of the substrate.

As used herein, “polyribonucleotide” refers to a polynucleotide comprising two or more modified or unmodified ribonucleotides and/or their analogs. In the present invention, a polynucleotide can be substituted with a polyribonucleotide.

As used herein, “probe,” “probe sequence,” and “probe region” are interchangeable and considered to be the portion of the first oligonucleotide that is designed to anneal to a target nucleic acid. Probe sequences can be arranged in an array of formats in the first oligonucleotide, and can be designed based on sequence, melting temperature (Tm), sequence accessibility, and more as described herein.

As used herein, “reverse complement” of an oligonucleotide sequence is a sequence that will anneal/basepair or substantially anneal/basepair to said oligonucleotide according to the rules defined by Watson-Crick base pairing and the antiparallel nature of the DNA-DNA, RNA-RNA, and RNA-DNA double helices. Thus, as an example, the reverse complement of the RNA sequence 5′-AAUUUGC would be 5′-GCAAAUU.

As used herein, “ribonucleotide” and “ribonucleic acid” (RNA) are interchangeable and refer to a modified or unmodified nucleotide or polynucleotide comprising at least one ribonucleotide unit. A ribonucleotide unit has oxygen attached to the 2′ position of a ribosyl moiety having a nitrogenous base attached in N-glycosidic linkage at the 1′ position of a ribosyl moiety, and a moiety that either allows for linkage to another nucleotide or precludes linkage.

As used herein, “RISC” refers to the set of proteins that complex with single-stranded polynucleotides such as mature miRNA or siRNA, to target nucleic acid molecules (e.g., mRNA) for cleavage, translation attenuation, methylation, and/or other alterations. Known, non-limiting components of RISC include Dicer, R2D2 and the Argonaute family of proteins, as well as strands of siRNAs and miRNAs.

As used herein, “RNA interference” and “RNAi” are interchangeable and refer to the process by which a polynucleotide (e.g., miRNA or siRNA) comprising at least one ribonucleotide unit exerts an effect on a biological process. The process includes, but is not limited to, gene silencing by degrading mRNA, attenuating translation, interactions with tRNA, rRNA, hnRNA, cDNA and genomic DNA, as well as methylation of DNA with ancillary proteins.

As used herein, “seed” and “seed region” are interchangeable and refer to positions 2-7 or 2-8 on the sense or antisense strand of the siRNA or miRNA.

As used herein, “sense strand” refers to a polynucleotide or region that has the same nucleotide sequence, in whole or in part, as a target nucleic acid such as RNA or DNA. Correspondingly, the probe region of the present invention can considered to be an antisense strand when the target nucleic acid is considered to be a sense strand. When a sequence is provided, unless otherwise indicated, it is the sense strand (or region), and the presence of the complementary antisense strand (or region) is implicit. The phrases “sense strand” and “sense region” are intended to be equivalent and are used interchangeably.

As used herein, “short interfering RNA” and “siRNA” are interchangeable and refer to unimolecular nucleic acids and to nucleic acids comprised of two separate strands that are capable of performing RNAi and that have a duplex region that is between 18 and 30 base pairs in length. Additionally, siRNA include nucleic acids that also contain moieties other than ribonucleotide moieties, including, but not limited to, modified nucleotides, modified internucleotide linkages, non-nucleotides, deoxynucleotides, and analogs of the aforementioned nucleotides.

As used herein, “substrate” and “solid support” are interchangeable and refer to a material to which the linker region of the first oligonucleotide is associated with. A microarray site is an example of a substrate.

As used herein, “target,” “target sequence” and “target nucleic acid” are interchangeable and refer to a polynucleic acid sequence to which the probe region of the first oligonucleotide is designed to anneal. Target sequences can exist in the pri-miRNA, pre-miRNA, mature miRNA, one or both strands of siRNA, tRNA, mRNA, cDNA, and the like.

### II. Microarray

In one embodiment, the present invention includes a microarray configured for detecting the presence and/or amount of a target nucleic acid in a sample. As such, the microarray can include a plurality of microarray sites, where each microarray site can include at least one polynucleotide trap or an enhance polynucleotide trap. While a microarray site can include multiple polynucleotide traps each configured for targeting different target nucleic acids, each array site usually has one type of polynucleotide trap configured for targeting a single nucleic acid. Also, a microarray site can include any polynucleotide trap or enhanced polynucleotide trap.

For simplicity, reference to a polynucleotide trap can include an enhanced polynucleotide trap unless the enhancer oligonucleotide is explicitly excluded. The polynucleotide trap can include a first oligonucleotide having a probe region and a linker region, and can include a second oligonucleotide (e.g., enhancer oligonucleotide) having an enhancer region. The microarray site can be configured such that the first oligonucleotide is coupled to a substrate through the linker region. For example, the 5′ end or 3′ end of the linker region (or first oligonucleotide) can be coupled to the substrate. Coupling nucleic acids to substrates in microarrays is well known in the art.

The first oligonucleotide can include at least two regions. The first region, which can be referred to as the linker region, can be configured to couple the first oligonucleotide to the substrate. The second region, which can be referred to as the probe region, can be coupled to the linker region and can have a sequence that is at least substantially complementary to a target nucleic acid, such as a target oligonucleotide. The second oligonucleotide, which can be referred to as an enhancer oligonucleotide, can be configured so as to be capable of annealing to the linker region of the first oligonucleotide. The portion of the enhancer oligonucleotide that is configured to hybridize with the linker region can be referred to as an enhancer region. When the enhancer region hybridizes with the linker region the polynucleotide trap can be characterized as having minimized interactions between the linker region and/or probe region with the solid support, and/or minimized interactions between the probe and the linker. Also, the enhancer oligonucleotide can enhance the rigidity or extension of the linker region, and can thereby maximize the ability of the probe region to be available for hybridizing with target nucleic acids, such as miRNA.

Accordingly, the composition of the solid support of the microarray site and the method by which the first oligonucleotide is attached thereto can vary. Acceptable solid supports include glass, nylon, and other art-recognized compositions known at this time and identified in the future. While the attachment of the first oligonucleotide to the solid support can occur through either the 5′ or 3′ end of the linker, preferably the linker is attached to the solid support at the 3′ end. Methods of attaching the first oligonucleotide to the substrate can vary greatly and include synthesizing the polynucleotides at the desired position on the microarray (U.S. Pat. No. 5,445,934) or by pre-synthesizing the polynucleotides and attaching them to the solid support (e.g., direct spotting).

The microarray in accordance with the present invention can be configured substantially the same as any of the various well-known microassay plates. Such microassay plates can be comprised of glass, plastic, silicon, and the like. Alternatively, the microarrays can be produced on glass slides. An example of a microarray that is compatible with the invention includes the Agilent and Affymetrix microarray platforms configured as described herein. Such arrays can be pre-designed and synthesized, or custom designed. For example, custom microarray materials can be ordered through the Agilent E-array website.

The immobilized polynucleotide traps coupled to the substrate of the microarray site can be used to construct arrays or microarrays for hybridization assays as described herein. A typical method of using microarrays involves contacting labeled oligonucleotides (e.g., target oligonucleotide) contained in a fluid sample with the probe region of the polynucleotide trap immobilized on the microarrays under hybridization conditions, and then detecting the hybridization between the labeled oligonucleotide and the probe region of the polynucleotide trap. The resultant pattern of hybridized nucleic acids (e.g., probe-target) provides information regarding the profile of the nucleotide constituents in the sample.

In one embodiment, the present invention includes a microarray having a plurality of positions where targets or labeled targets can be annealed or trapped. The microarray can be configured to trap different species (e.g., sequences) of nucleic acid molecules at different locations or microarray sites on the microarray. Each position includes at least one first oligonucleotide consisting of a probe region coupled to a substrate through a linker region. Addition of an appropriate enhancer sequence can improve the sensitivity of the microarray. The microarray can be configured substantially the same as any of the various well-known microarray plates.

### III. First Oligonucleotide: Linker and Probe Regions

In one embodiment, the composition of the first oligonucleotide of the invention comprises a probe region coupled with a linker region. The probe region can be directly or indirectly coupled with the linker region. For example, the probe region can be directly, covalently bonded to the linker region, or the probe region can be covalently bonded to an intermediate polynucleotide region that in turn is covalently bonded to the linker region. This can include the 3′ or 5′ end of the probe region being coupled to the corresponding end of the linker region, and the other end of the linker (e.g., end not coupled to the probe region) can be coupled to the substrate of a microarray site.

1. Linker Region

The linker region of the first oligonucleotide can be configured to link the probe region to a substrate. As such, the linker region can be configured for at least one of the following: not interact with the probe sequence, the target sequence, or the substrate; have minimal secondary structure; not interact with itself (e.g., no unimolecular hybridization); separate the probe region from attaching directly to the substrate/attachment surface of the microarray site; and link the probe region with a substrate of the microarray site in a manner that presents the probe region for hybridizing with the target nucleic acid. The attribute of minimal secondary structure is particularly desirable and can inhibit the linker region, or first oligonucleotide in general, from folding back upon itself, and thereby increases the availability of the probe region.

The linker can be varied in any length and sequence composition. Preferably, the linker is at least 13-100 nucleotides in length. More preferably, the linker length is 13-70 nucleotides. Even more preferably, the linker length is between 13-50 nucleotides.

While the composition of the linker region can vary greatly, pyrimidine-rich (e.g., polypyrimidine) linkers can be used to inhibit secondary structures. Also, purine-rich linkers can be used. Pyrimidine or purine-rich sequences are rare in the genome, and can be used in linker regions in order to minimize the opportunities for native sequences (e.g., mRNA or miRNA sequences derived from a cell) to anneal with the linker region. In addition, polypyrimidine sequences have a high degree of conformational freedom, and therefore are not locked into a single structural form. Having a broad set of conformations in the linker region allows the probe region to be oriented in a range of positions, which is optimal for annealing to target nucleic acids of various sizes. Taking the size and composition preferences into consideration, examples of linker regions include: ctcttctctctcttctct (SEQ ID NO: 1), ctcttctctc (SEQ ID NO: 2); ctcttctctctcttctctctcttctctctcttctct (SEQ ID NO: 3); and ctcttctctctcttctctctcttctctctcttctctct (SEQ ID NO: 4); or other similar, non-structured sequences of any length or combination; combination thereof; or derivative thereof. A derivative of the polynucleotide sequence can include a portion of the sequence, and/or the nucleotides being analogs or having modifications as described herein.

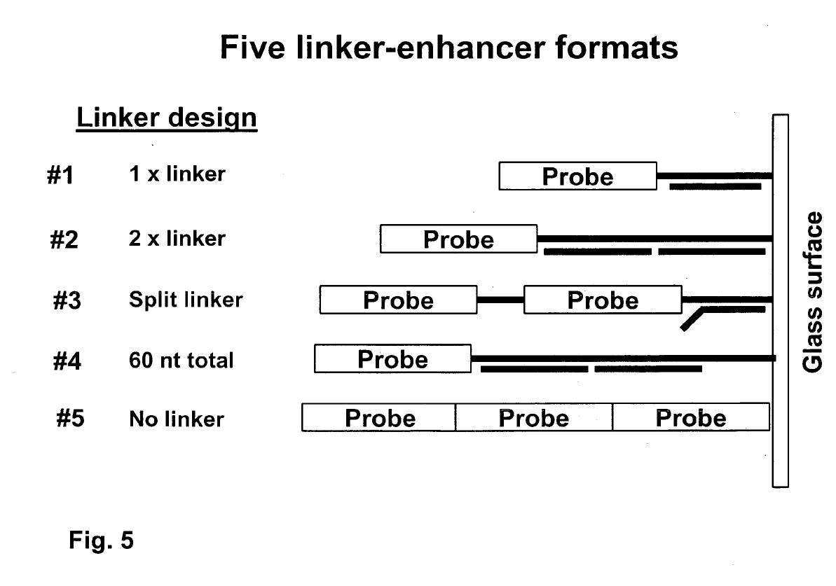

FIG. 5 shows different linker designs. As such, a first oligonucleotide can include the following: a single linker (linker design #1), at least two linker regions sequentially coupled together, wherein the two linker regions can have the same or different sequences (linker design #2); a first linker coupling a first probe with a substrate and a second linker coupling the first probe with a second probe (linker design #3); and at least two linker regions sequentially coupled together and being coupled to a substrate through an intermediate region, wherein the two linker regions can have the same or different sequences (linker design #4).

While it is not required that all of the linkers associated with a microarray site are of the same length and sequence composition, for manufacturing purposes, homogeneity amongst linker sequences on a single array is preferred. Additionally, the linker region can be configured to include any of the following: at least one 2′ carbon modification; at least one 2′-O-alkyl modified nucleotide; at least one modified base; at least one nucleotide analog; or combinations thereof. The linker region can be synthesized as described herein or in the incorporated references as is well known in the art of nucleic acid chemistry, DNA chemistry, and/or RNA chemistry.

2. Probe Region

The probe region of the first oligonucleotide can configured to have a sequence that has at least substantial complementarity with respect to a target nucleic acid. As such, the probe region is designed to be capable of hybridizing to a target nucleic acid. The probe region can range in size between 12 and 27 nucleotides (although other lengths can be used where appropriate). For example, the probe region can range from 14 to 25 nucleotides, or can be configured to be from 19 to 21 nucleotides. As described above, the probe region can be linked to the 3′ or 5′ end of the linker region of the first oligonucleotide. That is, the probe region can be covalently coupled with the end of the linker region that is not coupled to the substrate of the microarray site. However, the probe region is typically described in antisense terminology so that the probe region forms an antisense orientation with the target having the sense orientation.

The probe region can have >70% complementarity to the target nucleic acid, more preferably >80% complementarity, even more preferably >90% complementarity, and most preferably about 100% complementarity to the target nucleic acid. In any event, the probe can hybridize with the target nucleic acid.

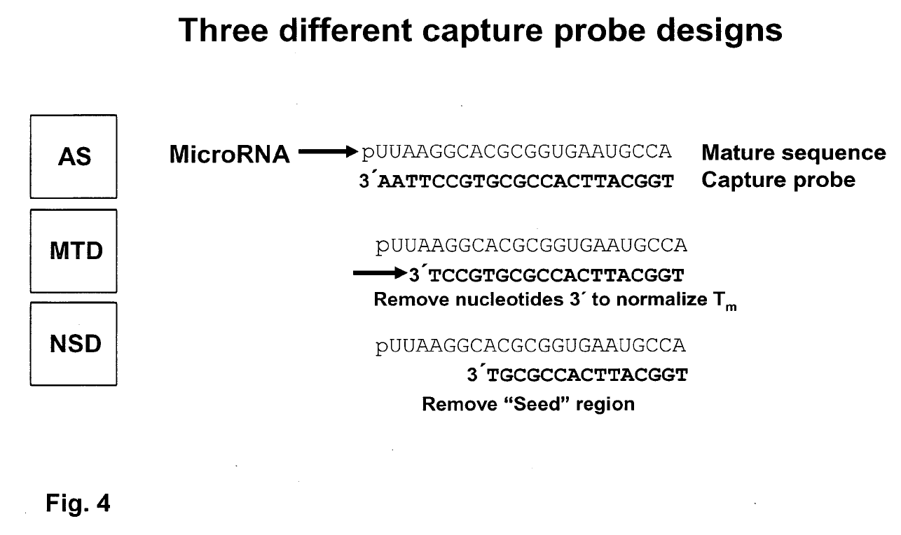

FIG. 4 illustrates a probe region being designed based on the sequence of a target miRNA. As such, the probe can be configured as follows: 1) designed to anneal to the full-length mature miRNA strand that enters RISC (antisense design); 2) designed based on the melting temperature (melting temperature design); or 3) designed to anneal to the mature strand sans the seed region (no seed design). Since many miRNA have common seed sequences, the “no-seed design” can enhance specificity for the probe hybridizing with the target miRNA. In cases where the probe sequences are designed based on melting temperatures, desired melting temperatures can be obtained by removing nucleotides from the 3′ end of the probe sequence until a desired melting temperature is obtained. Probe sequences for all three probe design strategies (e.g., antisense, melting temperature, and no seed) can developed from miRNA sequences that are deposited in the Sanger miRNA database website.

Probe regions that target long or short nucleic acids can also be engineered to have specified melting temperatures with the target nucleic acid. As such, probe-target duplexes can be designed to have different maximum and/or minimum melting temperatures depending on the needs of the experimental protocol. Usually, the minimal melting temperature is greater than the operating temperature of the microarray system. Thus, for example, a maximum melting temperature of about 45° C. to about 60° C. can be beneficial for functionality of probe regions. In another example, the maximum melting temperature can be between 55° C. and 60° C.

Additionally, the first oligonucleotide can include multiple probe regions. This can include the probe regions having the following: the same sequence; the same target nucleic acid; different sequences; different target nucleic acids; and the like. In the instance the first oligonucleotide includes multiple probe regions, such probe regions can be sequentially coupled, directly coupled, indirectly coupled with intermediate regions or linker regions separating sequential probe regions; and the like. FIG. 5 shows a first oligonucleotide having two probe regions separated by a linker region or an intermediate region (linker design #2), and having three sequential probe regions directly coupled to each other (linker design #5).

While it is not required that all of the probes associated with a microarray site are of the same length and sequence composition, for manufacturing purposes, homogeneity amongst probe sequences on a single microarray site is preferred. However, the probe sequences for different sites within a microarray typically vary, but can be the same in some instances. Additionally, the probe region can be configured to include any of the following: at least one 2′ carbon modification; at least one 2′-O-alkyl modified nucleotide; at least one modified base; at least one nucleotide analog; or combinations thereof. The probe region can be synthesized as described herein or in the incorporated references as is well known in the art of nucleic acid chemistry, DNA chemistry, and/or RNA chemistry.

The first oligonucleotide can be modified or unmodified DNA, RNA, or DNA/RNA hybrids, but preferably are ribonucleotide, modified ribonucleotides, deoxyribonucleotides, or modified deoxyribonucleotides. More preferably, the first oligonucleotide consists of deoxyribonucleotides. Most preferably, the first oligonucleotide consists of either deoxyribonucleotides or ribonucleotides, wherein any of the nucleotides on either oligonucleotide can be modified or a nucleotide analog. The first oligonucleotide can include modifications that enhance stability against nuclease degradation and prevent secondary structure.

### IV. Second Oligonucleotide: Enhancer Region

In one embodiment, the second oligonucleotide includes an enhancer region. As such, the second oligonucleotide can be referred to as the enhancer oligonucleotide. The enhancer region can include a polynucleotide sequence that is configured to have at least substantial complementarity with the linker region of the first oligonucleotide, thereby allowing the enhancer region to anneal with the linker region to form a duplex region. The formation of a duplex region between the enhancer and linker regions enhances the rigidity of the linker region and first oligonucleotide, and extends the probe region outwardly from the substrate attached to the other end of the linker region. Accordingly, the enhancer oligonucleotide can improve the accessibility of the probe region to potential target nucleic acids. In addition, formation of a duplex region between the enhancer and linker regions can prevent the linker from having adverse interactions with the probe region and/or substrate and can inhibit secondary structures.

FIG. 5 depicts embodiments of enhancer oligonucleotide configurations that can be included in a polynucleotide trap. As such, the enhancer oligonucleotide can be configured as follows: a single enhancer oligonucleotide coupled to the first oligonucleotide (linker design #2); at least two enhancer regions sequentially hybridized to a linker region, wherein the two enhancer regions can have the same or different sequences (linker design #2); an enhancer with an overhang, wherein a portion of the enhancer is hybridized with the linker region and a portion of the enhancer is an overhang that is not hybridized with the linker region, wherein the overhang can be on the probe side (as shown) or on the substrate side (linker design #3); and at least two enhancer regions sequentially hybridized to a linker region and having a gap between an enhancer region and the substrate (linker design #4).

The duplex region comprised of the hybridized enhancer/linker pair can include any unstructured pair of hybridized polynucleotides in accordance with the present invention. The duplex region can have a melting temperature greater than the maximum temperature that can be used for annealing the target nucleic acid to the probe region during the annealing step of a microarray procedure. While the length of the enhancer can vary considerably, it is preferable that the length of the enhancer sequence is smaller than or equal to the length of the linker. This can include the length of individual enhancers or multiple enhancers. As shown in Example 1 below, when the length of the enhancer is longer than the linker region, the performance of the system can be sub-optimal.

The enhancer region is at least substantially complementary to the linker region of the first oligonucleotide. Most preferably, the enhancer region is about 100% complementary to the linker sequence of the first oligonucleotide. In cases where the linker region is pyrimidine-rich (e.g. >50%, >75%, or >90%), the complementary enhancer is a purine-rich, and vice versa. It is worth noting that unlike pyrimidine-rich sequences that have a wide array of conformations, due to stacking, purine-rich sequences can have a small, defined set of structures that have conformations that are incompatible with classic Watson-Crick base pairing to the linker region of the first oligonucleotide.

In order to prevent the enhancer oligonucleotide from assuming undesirable structures, the enhancer sequence preferably contains a nucleotide modification, most preferably a 2′-carbon modification of the sugar moiety of the nucleotide. Preferably the 2′ carbon modification is a 2′-ACE or 2′-O-alkyl (e.g., a 2′-O-methyl or 2′-O-ethyl) modification at some or all of the nucleotides of the enhancer sequence. Preferably >50% of the nucleotides of the enhancer region contain 2′-O-alkyl and/or 2′ ACE modifications of the 2′ carbon of the ribose ring. More preferably >80% of the nucleotides of the enhancer sequence comprise 2′-O-methyl modifications, 2′ ACE modifications, or a combination of 2′-O-methyl modifications and 2′ ACE modifications. Most preferably, all (100%) of the nucleotides of the molecules of the enhancer sequence comprise 2′ ACE modifications and/or 2′-O-methyl modifications.

### V. Methods of Detecting Nucleic Acid

In one embodiment, the present invention includes a method of using the microarray having the polynucleotide trap in order to detect the presence of a target nucleic acid in a sample. Such a method can include the following: (a) obtaining a microarray having one or more polynucleotide traps that each include a first oligonucleotide having a probe region that is configured to hybridize with a target nucleic acid, wherein each polynucleotide trap is associated with a solid support via a linker region; (b) exposing the one or more polynucleotide traps to one or more enhancer oligonucleotides, wherein at least one of the enhancer oligonucleotides has at least substantial complementarity to the linker region of the first oligonucleotide under hybridizing conditions where the enhancer region and linker region anneal; (c) exposing the solid support containing the polynucleotide trap to a mixture containing labeled nucleic acid targets under conditions whereby the labeled nucleic acid targets can anneal to their respective probe regions; and (d) quantitating the amount of label associated with each probe or probe position (e.g., microarray site) on a microarray to determine the relative amount of nucleic acid target at each probe or probe position. In the method of detecting nucleic acids, steps (b) and (c) can take place successively. Alternatively, the enhancer sequence can be mixed with the labeled nucleic acid targets and the annealing reactions between linker and enhancer and between the probe and labeled target can take place simultaneously.

1. Methods of Labeling Nucleic Acids

A widely used method for detecting the hybridization complex in microarrays is by detecting fluorescence or other label. As described in the Examples section below, nucleic acids derived from a biological sample can be coupled to a fluorescent label molecule so as to create labeled nucleic acids (e.g., labeled targets). The labeled targets are then incubated with the microarray so that the targets hybridize to the probe regions of the polynucleotide trap immobilized on the microarray. A scanner is then used to determine the presence and/or levels and patterns of fluorescence. The invention is compatible with both single dye (e.g., Affymetrix), dual dye (e.g., Agilent) detection strategies, or with multiple dyes. For example, in the due dye case the test and control samples can be labeled with Cy3 and Cy5, respectively, and then can be mixed together and simultaneously hybridized to the microarray. Subsequently, the signal at any given position on the array is a representation of the relative amounts of a given target molecule in the test sample as compared with the level in the control.

A. Fluorescent Labels

Preferred fluorescent tags/labels used in direct labeling include the dyes denoted Cy3 and Cy5 (or closely related analogs) that fluoresce at approximately 550 nm and 650 nm, respectively. Such dyes can be added to the 5′ end, 3′ end, or internal region of the target nucleic acid. The oligonucleotide mixture can be labeled with a single fluorescent label, or multiple fluorescent tags that fluoresce at multiple wavelengths. In cases where multiple dyes are used in a single mixture, any number of different types of fluorescent tags could be used in place of, or in combination with the Cy3 and Cy5 tags including Alexa, Fluorescein, Rhodamine, FAM, TAMRA, Joe, ROX, Texas Red, BODIPY, FITC, Oregon Green, Lissarine, and others. Many of these dyes and derivatives can be obtained from commercial providers such as Molecular Probes (Eugene, Oreg.), Amersham Pharmacia (Bucks, United Kingdom), and Glen Research (Sterling, Vt.). In instances where multiple dyes are utilized, different dyes can label different oligonucleotides, or multiple dyes can label a single nucleotide. Such multi-color approaches are useful in the distinction of wild type and mutant expression profiles. Fluorescent labels can be added to target oligonucleotides by both enzymatic and non-enzymatic methods. Examples of enzymatic methods include the polyA polymerase technique (Ambion), while non-enzymatic techniques include MICROMAX ASAP RNA Labeling Kit (Perkin Elmer) and ULS labeling (Kreatech). The most preferable technique for labeling miRNA utilized hydrazine chemistry (see examples section and Tian-ping Wu, Kang-cheng Ruan, Wang-yi Liu (1996), “A fluorescence-labeling method for sequencing small RNA on polyacrylamide gel,” NAR 24 (17), p. 3472-3473).

B. Indirect Labels

Indirect labeling methods can also be applied to the invention and include, for example, labeling with biotin or dinitrophenol which are organic molecules that are not themselves fluorescent, but are reactive with antibody conjugates that are conjugated to fluorescent groups. Labels, haptens, or epitopes such as biotin and dinitrophenol, therefore allow fluorescent detection by indirect means because the fluorescence at each spot is contributed by the antibody conjugate that interacts with the microarray via interactions with the non-fluorescent label. Anyone skilled in the art will appreciate however, any number of direct and indirect labeling schemes could be used for detection including both fluorescent and non-fluorescent approaches.

2. Hybridization

Procedures for hybridization of labeled probes to the microarray have been described in detail (see, for instance, “A Beginners Guide to Microarrays” Blalock, E. M. Kluwer Academic Publishers; and “Microarrays Methods and Applications: Nuts and Bolts” by Hardiman, G. DNA Press). Generally, hybridization in accordance with the present invention can include pre-hybridization (hybridization between enhancer region and linker region), hybridization of probe region with the labeled sample, and washing steps. Successful hybridization involves identifying optimal temperatures, salt and foramide concentrations, and other reagents (e.g., detergents). Hybridization is preferably performed in a hybridization chamber (e.g., Corning, Agilent, Affymetrix) and takes place for 12-24 hours. Post-hybridization washes may require optimizing salt, detergent, and temperatures that are unique for each application.

3. Detection

Following hybridization with the labeled oligonucleotide mixture, the microarrays are scanned or read by known methods that detect the label. Examples of detection methods can include those commonly used to detect gene expression. Available scanners include, but are not limited to, the Gene Chip Scanner 3000 System (Affymetrix), the DNA Microarray Scanner (Agilent Technologies), the AlphaScan Microarray Scanner (Alpha Innotech), Applied Biosystems 1700 Chemiluminescent Microarray Analyzer (Applied Biosystems), arrayWoRx (Applied Precision, LLC), DNAscope AT (Biomedical Photometrics Inc), the VersArray ChipReader (Bio-Rad), and more. Microarrays can be read by any of the aforementioned devices and data can be stored for future analysis using software packages such as GeneSpring GT (Agilent Technologies), Rosetta Luminator (Agilent Technologies), Rosetta Resolver (Agilent Technologies), Bio-Plex Manager (Bio-Rad), ArrayStar FirstLight (DNA STAR), GeneTraffic (Iobion Informatics), and more.

### VI. Utility

The compositions, microarrays, polynucleotide traps, first oligonucleotides, enhancer oligonucleotides, and methods of the invention are applicable to basic research where researcher may wish to obtain nucleic acid profiles (e.g., miRNA profiles) to further the understanding of one or more biological processes. In one non-limiting example, labeled RNA samples from a cell, tissue, or sample can be compared with a collection of labeled control samples at various concentrations. In this way, a researcher can identify the presence of miRNA in the cell, tissue or sample and/or quantitate the level of each miRNA in a given cell, tissue, or sample. Moreover, the use of labeled control samples allows for a researcher to normalize data from chip to chip, therefore making it possible to compare results from different experiments.

In another non-limiting example, labeled RNA from a cell, tissue, or sample can be compared to a second cell, tissue, or sample to identify the differences in miRNA (or mRNA) profiles of different cells or tissue types. In another example, cells, tissues, or whole animals (e.g., mice, rats, rabbits, humans) can be treated with a biological active substance (e.g., a drug) and comparisons can be made between treated and untreated cells, tissues, or whole animals, to determine if the drug induces changes in miRNA (or mRNA) profiles. In yet another example, cells from one stage of normal differentiation can be compared with cells from another stage of differentiation to determine if changes in the cellular state can be correlated with changes in the miRNA (or mRNA) profile. In another non-limiting example, the miRNA (or mRNA) profile of a normal cell can be compared with the profile of a diseased cell, to determine whether the disease state can be correlated with changes in the expression of one or more miRNA (or mRNA).

The compositions, microarrays, polynucleotide traps, first oligonucleotides, enhancer oligonucleotides, and methods of the invention are also applicable to clinical and diagnostic settings in order to obtain miRNA profiles or other nucleic acid profiles of patients suffering one or more ailments or to determine the predisposition of one or more individuals to an ailment or disease. In one non-limiting example, in cases where particular miRNA profiles or subsets of miRNA profiles correlate with particular disease states, tissues samples from a diseased patient may be analyzed using the compositions and methods of the invention to determine the state or stage of the disease or predisposition to a disease. Such information may be of great value to clinicians in determining treatment strategies for patients.

### EXAMPLES

### I. Synthesis and Modifications of RNA

The test RNAs used in the following examples were synthesized using compositions of matter and methods, or modified compositions of matter and methods described in the following references: Scaringe, S. A. (2000), “Advanced 5′-silyl-2′-orthoester approach to RNA oligonucleotide synthesis,” Methods Enzyme 317, 3-18; Scaringe, S. A. (2001), “RNA oligonucleotide synthesis via 5′-silyl-2′-orthoester chemistry,” Methods Enzyme 23, 206-217; U.S. Pat. No. 5,889,136; U.S. Pat. No. 6,008,400; U.S. Pat. No. 6,111,086; and U.S. Pat. No. 6,590,093.

### II. Custom Microarrays

Custom Microarrays containing various linker-probe oligonucleotide designs capable of annealing to target miRNA sequences were ordered through the Agilent E-array website.

The periodate/hydrazide labeling method was employed to label RNAs used in the following experiments. In one example, ten micrograms of total RNA (in 10 microlites of distilled deionized water) was treated with sodium periodate (2 microliters, 0.1M, Pierce Chemical, PI20504) for 5 minutes at room temperature. Subsequently, 2 microliters of 0.2 M sodium sulfite (Acros, AC21927-0250) was added to the reaction. Following a 5 minute, incubation at room temperature, 14 microliters of sodium acetate (0.1M, pH5.0) and 3.7 microliters of hydrazide modified Cy3 or Cy5 (10 mM in DMSO, Amersham Scientific) were added. The mixture was first incubated at 60° C. (30 minutes) followed by a 1 minute incubation on ice. Cyanoborhydrate (2.5 microliters of a 0.2 M solution of sodium cyanoborohydrate in ethanol) was then added (15 minutes at room temperature) and the free dye was then removed using a G-25 column (Amersham). In cases where biological samples are being labeled (e.g., containing both mRNAs and miRNAs, a fragmentation step was added to the protocol to minimize background. Fragmentation involved combining 100 ul of RNA (˜10 ug of RNA total), with 4 microliters of 25× fragmentation buffer (Agilent). After 30 minutes at 60° C., the ACE-modified enhancer sequence was added. Hybridization followed.

### III. Hybridizing and Washing

Standard hybridization and wash protocols available at the Agilent web site were used for all of the studies described herein. The Agilent Microarray Scanner (model G2505B) in conjunction with Agilent's Feature Extraction, Spotfire DecisionSite, and Spotfire Functional Genomics software (versions 7.2, 7.2, and 7.1, respectively) was used to assess the intensity of spots on each microarray.

### Example 1

### Oligonucleotide Designs

The probe sequences of the first oligonucleotide were designed to be the reverse complement of known human miRNAs. Linker sequences were one of four different designs, designated ND1, ND2, ND3, and ND4. In all cases, the linker designs were tested in the presence or absence of an appropriate enhancer sequence to determine the relative value of the enhancer with each linker, and ND5 (no linker) was utilized as a baseline comparative.

Linker sequence designs ND1→ND4 were as follows: ND1 has a single 5′ probe sequence associated with a 1× linker that has the sequence 5′-probe-ctcttctctctcttctct-3′ (5′-probe-SEQ ID NO 1); ND2 has a single 5′ probe sequence associated with two tandem linkers that generate the full linker sequence of 5′-probe-ctcttctctctcttctctctcttctctctcttctct-3′ (5′-probe-SEQ ID NO 3); (c) ND3 has two probe sequences with two short linker sequences so that the oligonucleotide is 5′-probe-ctct-probe-ctcttctctc-3′(5′-probe-ctct-probe-SEQ ID NO 2); (d) ND4 has a single 5′ probe sequence associated with a long linker sequence. As a result, the final oligonucleotide 5′-probe-ctcttctctctcttctctctcttctctctcttctctct-3′ (5′-probe-SEQ ID NO 3); and (e) ND5 was prepared with a tandem array of probes and have the organization of 5′-probe-probe-probe-3′ (See FIG. 5). Thus, each ND5 sequence is unique to the probe. The enhancer sequence used in these experiments was a 2′-ACE modified reverse complement of the 1× linker: 3′-GAGAAGAGAGAGAAGAGA (SEQ ID NO 5). Thus in the case of ND 1, there is a single position for the enhancer to bind, for ND2, two enhancer sequences can anneal, ND3, a single enhancer can partially bind to the linker that is proximal to the substrate surface, and ND4, two enhancer sequences can bind at positions that are at the distal region of the linker (see FIG. 5). For design ND5, the enhancer sequence represents three tandem repeats of the reverse complement of the respective probe. Following design, custom microarrays were ordered through the Agilent e-array website.

The miRNA target sequences used in these studies were designed using the mature sequences downloaded from the Sanger microRNA website. These 5′-phosphorylated sequences were synthesized using 2′-ACE chemistry (see above) and labeled with Cy5 or Cy3 using the periodate/hydrazide labeling protocol (described above).

To study the benefits of the enhancer sequence, microarrays containing each of the probe-linker designs were tested in the presence or absence of the enhancer. In one non-limiting protocol, microarrays containing roughly 500 different probes in each of the four designs were overlayed with 300 microliters of the hybridization solution. In the case where the enhancer was present, the solutions included: 3 micromolar enhancer+16 nanomolar Cy3 probe (˜33 picomolar of each labeled probe)+16 nanmolar Cy5 probe (˜33 picomolar of each labeled probe) in the standard Agilent hybridization solution. Both Cy3 and Cy5 labeled probes were added to the hybridization mix to determine whether either dye introduced a bias in the functionality of the designs. In cases where the enhancer was absent, microarrays were hybridized with equivalent concentrations of probes in the absence of enhancer sequences. Hybridizations took place overnight (˜17 hours) at 53° C. Subsequently, microarrays were washed at room temperature using standard Agilent wash solutions.

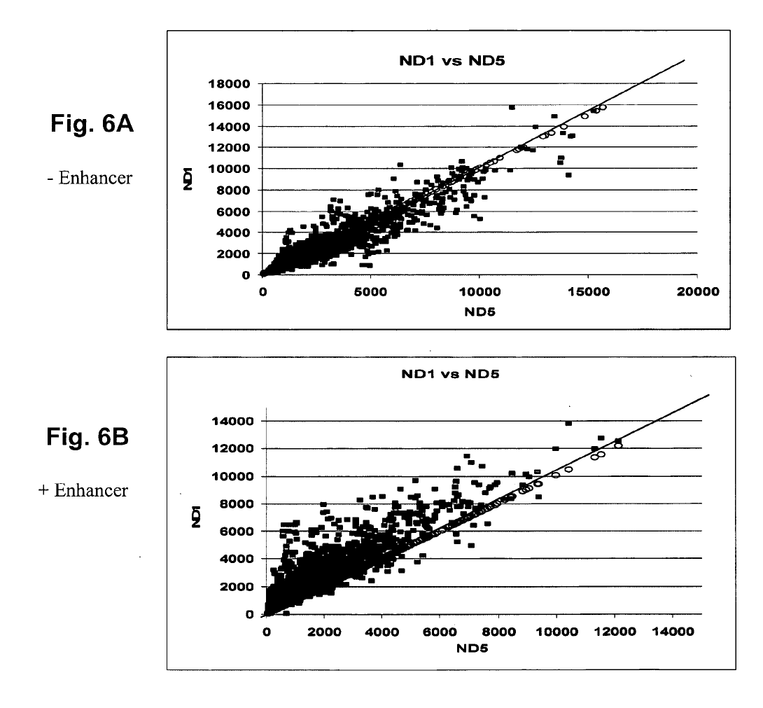

The results of these experiments are presented in FIGS. 6-9. FIG. 6A compares the signal intensity of ˜500 different probes that utilize either the ND1 or ND5 designs. The open circles (straight line) represent the ND5 signal intensity (in ascending order) for each target-probe pair plotted against itself. In the absence of the enhancer oligonucleotide, the fluorescence intensity of probe-target pairs having the ND1 design cluster around the ND5 performance curve, suggesting that the ND1 design by itself has no benefits over ND5. In contrast, in the presence of the enhancer sequence (FIG. 6B) the signal intensity of the majority of probe-target pairs having the ND1 designs is shifted above the ND5 performance curve, supporting the claims that addition of the ND1 enhancer greatly improves the sensitivity of the microarray.

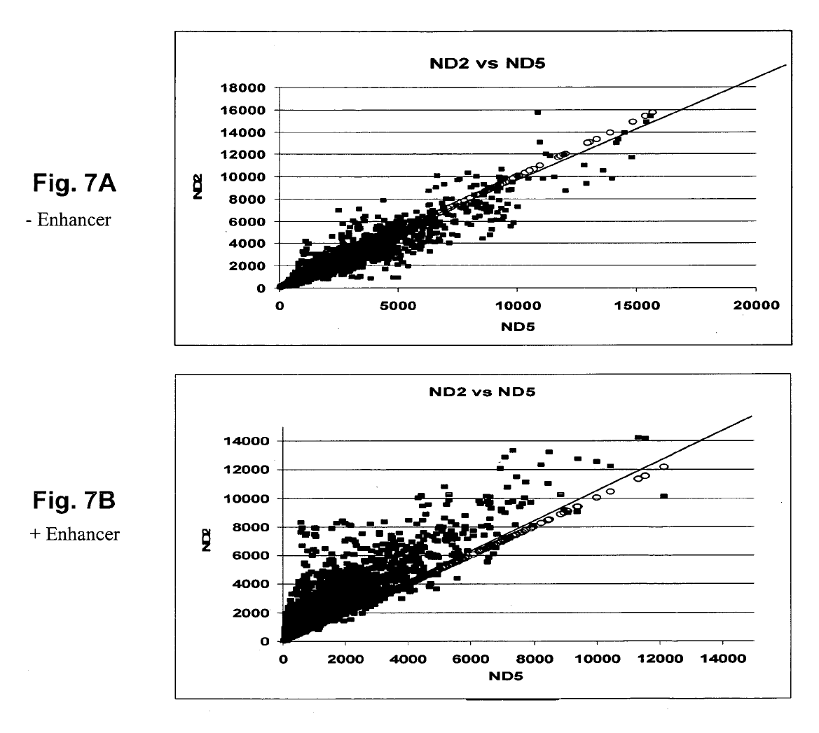

FIG. 7A compares the signal intensity of ˜500 different probes that utilize either the ND2 or ND5 designs. Again, the open circles (straight line) represent the ND5 signal intensity (in ascending order) for each target-probe pair plotted against itself. In the absence of the enhancer oligonucleotide, the fluorescence intensity of probe-target pairs having the ND2 design cluster around the ND5 performance curve suggesting that the ND2 design by itself has no benefits over ND5. In contrast, in the presence of the enhancer sequence (FIG. 7B), the signal intensity of the majority of probe-target pairs having the ND2 designs is shifted above the ND5 performance curve, supporting the claims that addition of the ND2 enhancer greatly improves the sensitivity of the microarray.

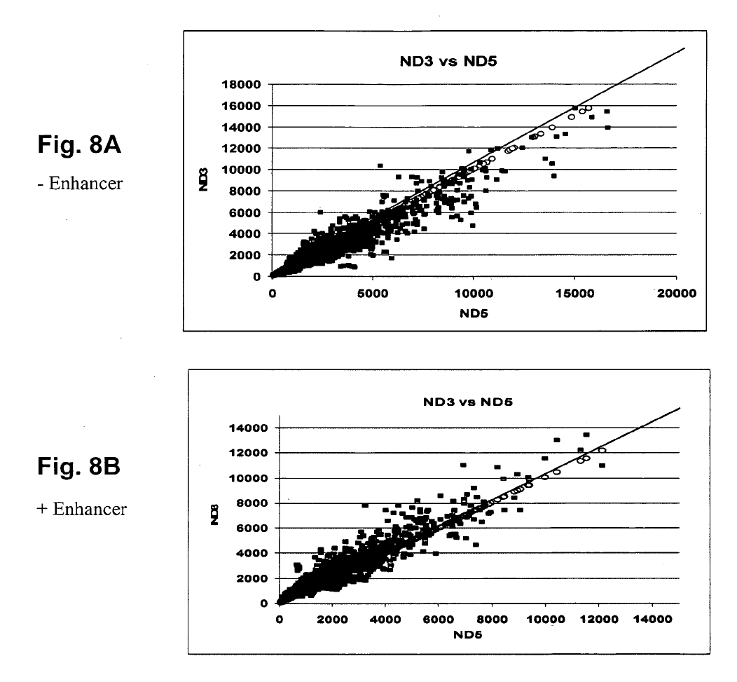

FIG. 8A compares the signal intensity of ˜500 different probes that utilize either the ND3 or ND5 designs. Again, the open circles (straight line) represent the ND5 signal intensity (in ascending order) for each target-probe pair plotted against itself. In the absence of the enhancer oligonucleotide, the fluorescence intensity of probe-target pairs having the ND3 design cluster around the ND5 performance curve suggesting that the ND3 design by itself has no benefits over ND5. Interestingly, addition of the enhancer for this particular design provides no improvement (FIG. 8B), suggesting that the split-design of ND3 is incompatible with the enhancer technology.

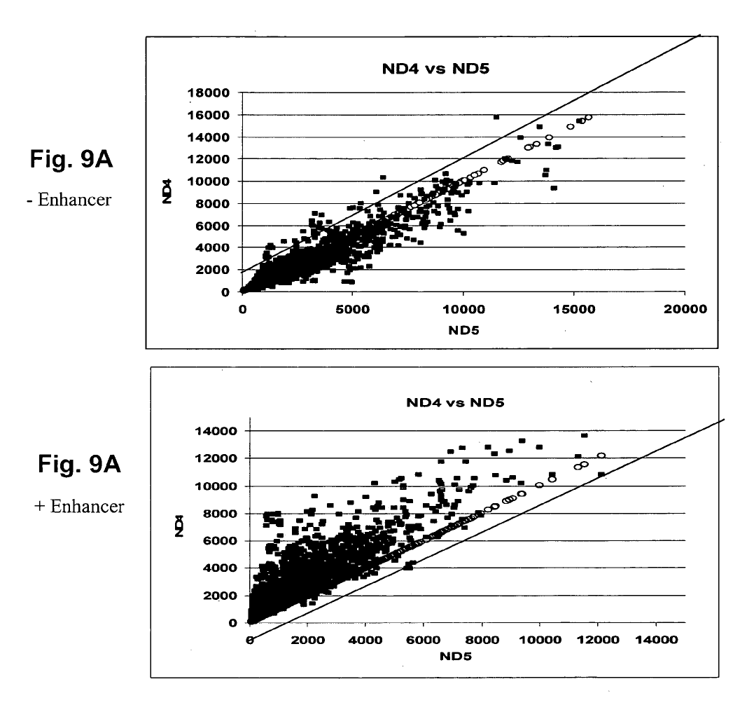

FIG. 9A compares the signal intensity of 500 different probes that utilize either the ND4 or ND5 designs. As was the case previously, the open circles (straight line) represent the ND5 signal intensity (in ascending order) for each target-probe pair plotted against itself. In the absence of the enhancer oligonucleotide, the fluorescence intensity of probe-target pairs having the ND4 design cluster around the ND5 performance curve, suggesting that the ND4 design by itself has no benefits over ND5. In contrast, in the presence of the enhancer sequence (FIG. 9B) the signal intensity of the majority of probe-target pairs having the ND4 designs is shifted above the ND5 performance curve, supporting the claims that addition of the ND4 enhancer greatly improves the sensitivity of the microarray.

The results of these studies clearly demonstrate that for most designs, addition of an enhancer sequence improves overall sensitivity of the microarray profiling.

### Example 2

### Studying the Effects of Enhancer Concentration on Performance

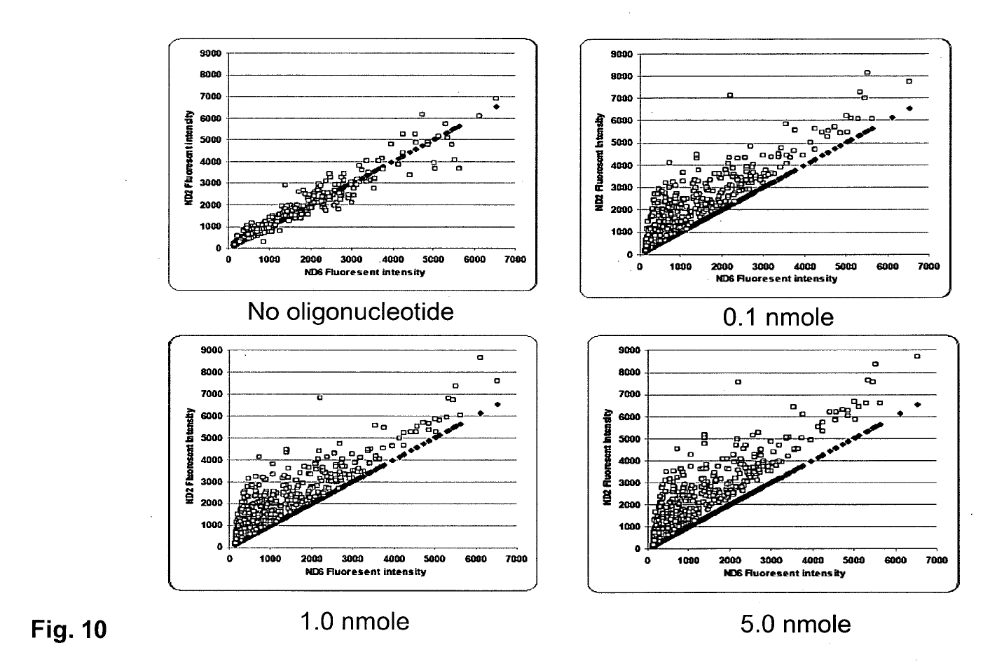

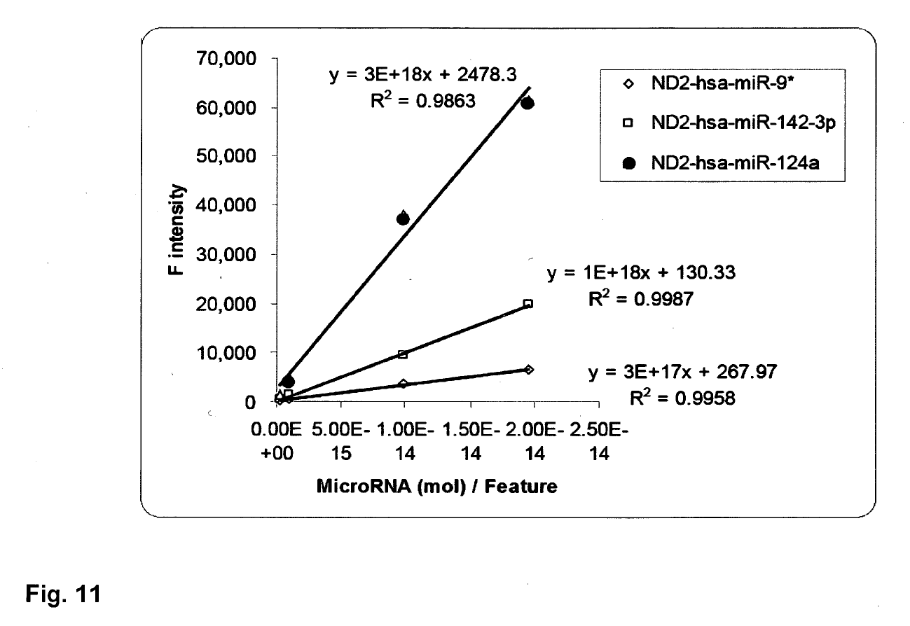

To investigate the effects of enhancer concentration on performance, the experiments described in Example 1 were repeated using enhancer concentrations ranging from 0.1-5 nanomoles per reaction in conjunction with the ND2 design (probe-2× linker). The results of these studies (FIG. 10) demonstrate near equivalent levels of performance over this 50-fold range of enhancer.

### Example 3

### Sensitivity of the ND2 Design

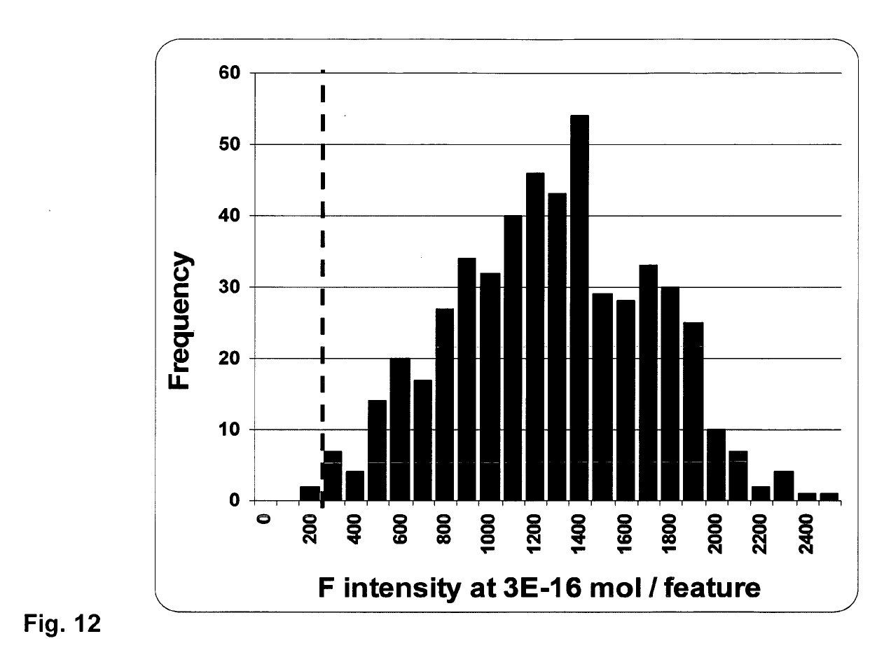

To test the overall sensitivity of the ND2 design, three different targets, the roughly 500 labeled miRNA probes were hybridized to microarrays at varying concentrations. A subset of these results (hsa-miR9, hsa-miR142-3p, and hsa-miR-124a) are shown in FIG. 11 and show that while the dose curves are different for each probe, all of the curves are linear in biologically relevant ranges. Thus, in cases where users are interested in the expression level of any given miR, concentration curves can be run side by side with experimental studies, enabling the determination of individual miR concentrations in one or more tissues. Examination of the total subset of fluorescent intensities at the lowest concentrations studied (3×10-16 mol) show that under the conditions of the invention, 98% of the targets can be distinguished from background at these extremely low concentrations (FIG. 12).

### Example 4

### Testing Microarray Designs of the Invention with Biological Samples

The optimal microarray designs described in Example 1 were implemented in an experiment designed to compare the relative abundance of all microRNAs from two different tissue samples (liver and brain). To accomplish this, total human brain and liver RNAs (containing both messenger RNAs and miRNAs) was purchased from Ambion. The RNA for each tissue sample was resuspended in 10 μL of distilled water and reacted with 2 μL of 0.1 M Sodium periodate (Acros, catalog number 198380050) for 5 minutes at room temperature. Next, 2 μL of 0.2 M Sodium sulfite (Acros, catalog number 21927025) is added to the sample and incubated for 5 minutes at room temperature. 14 μL of 0.1 M Sodium acetate, pH 5.0 (Acros, catalog number 424260250) is then added to the solution and mixed well. For labeling, 3.7 μL of 10 mM of either hydrazide modified Cy3 or Cy5 (Cy3-GE/Amersham, PA13121, Cy5-GE/Amersham, PA15121) was added to the mixture and incubated at 60° C. for 30 minutes. The reaction was cooled on ice and 2.5 μL of 0.2 M Sodium cyanoborohydrate was added to the mixture. Excess dye was then removed from the reaction by passing the sample over a size exclusion column (G25, Amersham). Subsequent, the samples were fragmented. Ten micrograms of Cy5 labeled total mRNA from brain and an equivalent amount of Cy3 labeled mRNA from liver in H2O to 100 μL were combined with 4 μL of 25× fragmentation buffer (Agilent catalog number, 5185-5974). The sample was incubated at 60° C. in the dark for 30 minutes. The sample was then combined with 100 microliters of 2× hybridization buffer and the entire sample was loaded into an Agilent hybridization chamber. Hybridization took place at 60° C. 16-20 hours in a hybridization oven (Agilent, G2545A) with a rotation speed of 4 RPM.

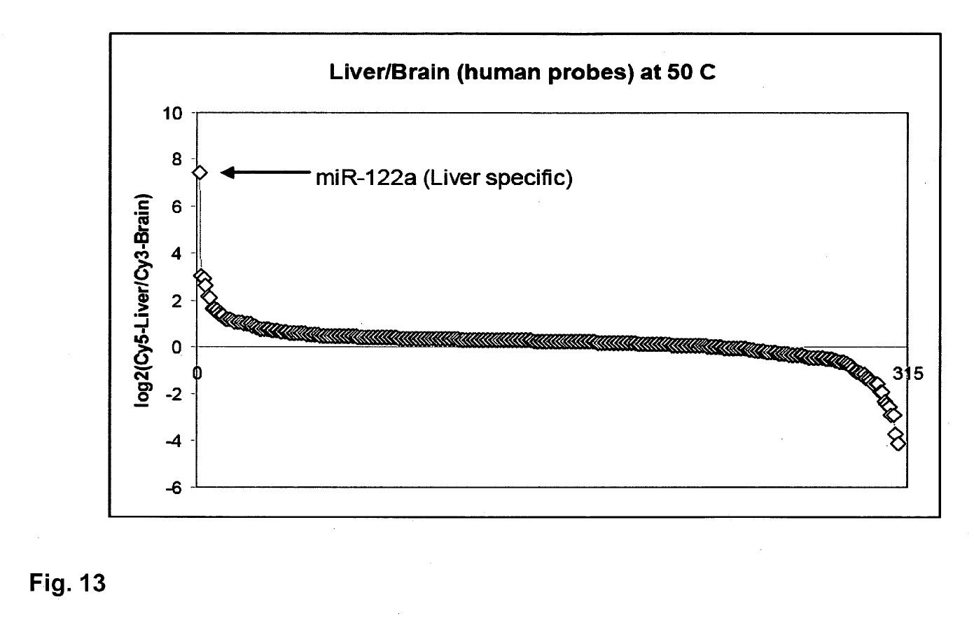

The relative ratios of each miRNA in liver versus brain are shown in FIG. 13. Each point on the X axis represents a separate miRNA and the Y-axis represents the relative ratio of the expression of that miRNA in liver versus brain. As one can see, the expression level of the majority of siRNAs is equivalent in both tissues. Yet several siRNAs show highly specific tissue expression patterns (e.g., miR122a, miR124). This experiment demonstrates the ability of the technique to identify miRNAs that are differentially expressed in different tissues.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. Additionally, various references have been cited herein, and each cited reference is incorporated herein in its entirety by specific reference.

What is claimed is:

1. A microarray for use in capturing a target polynucleotide contained in a sample, the microarray comprising:
a microarray substrate;
a first oligonucleotide comprising:
a probe region having a probe sequence capable of hybridizing with the target polynucleotide; and
a linker region having a linker sequence, a first end of said linker region coupled to an end of the probe region and a second end of said linker region coupled to the substrate; and
a second oligonucleotide having an enhancer region with an enhancer sequence capable of hybridizing with the linker sequence to form a duplex region, wherein the duplex region extends the probe region from the substrate.

2. A microarray as in claim 1, wherein the linker region has a length of from about 13 to about 100 nucleotides.

3. A microarray as in claim 2, wherein the linker region has a length of from about 13 to about 50 nucleotides.

4. A microarray as in claim 1, wherein the linker sequence consists of modified or unmodified pyrimidine nucleotides and the enhancer sequence consists of modified or unmodified purine nucleotides.

5. A microarray as in claim 1, wherein the enhancer sequence consists of modified or unmodified pyrimidine nucleotides and the linker sequence consists of modified or unmodified purine nucleotides.

6. A microarray as in claim 4, wherein the linker region comprises a sequence selected from the group consisting of SEQ ID NO: 1, SEQ ID NO: 2, SEQ ID NO: 3, SEQ ID NO: 4, combinations thereof, and derivative thereof.

7. A microarray as in claim 5, wherein the enhancer region comprises a sequence selected from the group consisting of SEQ ID NO: 1, SEQ ID NO: 2, SEQ ID NO: 3, SEQ ID NO: 4, combinations thereof, and derivative thereof.

8. A microarray as in claim 1, wherein the enhancer sequence has greater than about 70% complementarity with the linker sequence.

9. A microarray as in claim 1, wherein the enhancer sequence has about 100% complementary with the linker sequence.

10. A microarray as in claim 1, wherein the linker sequence and enhancer sequence are hybridized so as to inhibit the probe region from interacting with the linker region or substrate.

11. A microarray as in claim 1, wherein the probe region has a length from about 12 to about 27 nucleotides.

12. A microarray as in claim 1, wherein the probe region has a length from about 19 to about 21 nucleotides.

12. A microarray as in claim 1, wherein the probe region has greater than about 70% complementarity with the target polynucleotide.

13. A microarray as in claim 1, wherein the probe region has greater than about 90% complementarity with the target polynucleotide.

14. A microarray as in claim 1, wherein the length of the enhancer sequence is smaller than or equal to the length of the linker.

15. A microarray as in claim 1, wherein the probe sequence is configured to anneal to a mature miRNA strand sans a seed region.

16. A microarray as in claim 1, wherein the probe region and the target polynucleotide are capable of hybridizing with a maximum melting temperature from about 45° C. to about 60° C.

17. A microarray as in claim 1, wherein the probe region is linked to a 5′ end of the linker region.

18. A microarray as in claim 1, wherein at least one of the linker region, probe region, or enhancer region includes at least one modified nucleotide

19. A microarray as in claim 18, wherein the modified nucleotide is a 2′ modification.

20. A microarray as in claim 19, wherein the 2′ modification is selected from the group consisting of 2′ ACE modifications, 2′-O-alkyl modifications, and 2′-O-methyl modifications.

21. A microarray as in claim 1, wherein the substrate is selected from the group consisting of glass, plastic and silicon.

22. A microarray as in claim 1, wherein the target polynucleotide is miRNA.

23. A method for detecting a target polynucleotide in a sample using a microarray, the method comprising:
providing a microarray having a plurality of array locations, each array location comprising:
a substrate;
a plurality of first oligonucleotides, each first oligonucleotide comprising:
a probe region having a probe sequence capable of hybridizing with the target polynucleotide; and
a linker region having a linker sequence, a first end of said linker region coupled to an end of the probe region and a second end of said linker region coupled to the substrate; and
a plurality of second oligonucleotides, each second oligonucleotide having an enhancer region with an enhancer sequence capable of hybridizing with the linker sequence to form a duplex region, wherein the duplex region extends the probe region from the substrate;
contacting a sample having the target polynucleotide to the microarray; and
determining whether the sample contains the target polynucleotide.

24. A method as in claim 23, further comprising determining an amount of the target polynucleotide annealed to the probe regions of the first oligonucleotides.

25. A method as in claim 24, wherein the target polynucleotide is labeled, and the amount of target polynucleotide is determined by quantifying the amount of label.

26. A method as in claim 25, wherein the label is a fluorescent label.

27. A method as in claim 23, wherein the target polynucleotide is miRNA.


SEQUENCE LISTING (8 sequences)

SEQ ID NO: 1 - DNA, 18 bp, Artificial
  synthetic
ctcttctctctcttctct

SEQ ID NO: 2 - DNA, 10 bp, Artificial
  synthetic
ctcttctctc

SEQ ID NO: 3 - DNA, 36 bp, Artificial
  synthetic
ctcttctctctcttctctctcttctctctcttctct

SEQ ID NO: 4 - DNA, 38 bp, Artificial
  synthetic
ctcttctctctcttctctctcttctctctcttctctct

SEQ ID NO: 5 - DNA, 18 bp, Artificial
  synthetic
gagaagagagagaagaga

SEQ ID NO: 6 - DNA, 10 bp, Artificial
  synthetic
gagaagagag

SEQ ID NO: 7 - DNA, 36 bp, Artificial
  synthetic
gagaagagagagaagagagagaagagagagaagaga

SEQ ID NO: 8 - DNA, 38 bp, Artificial
  synthetic
gagaagagagagaagagagagaagagagagaagagaga